(19) United States
(12) Patent Application Publication
(10) Pub. No.: US 2009/0195401 A1
(43) Pub. Date: Aug. 6, 2009

(54) Apparatus and method for surveillance system using sensor arrays

(76) Inventors: Andrew Maroney, Bristol (GB); Peter Burke, Gwent (GB); Richard French, Langstone (GB)

Correspondence Address: BRANDON N. SKLAR. ESQ. (PATENT PROSECUTION);KAYE SCHOLER, LLP, 425 PARK AVENUE, NEW YORK, NY, 10022-3598, US

(21) Appl. No.: 12/010,941

(22) Filed: Jan. 31, 2008

(51) Int. Cl. G08B 21/00

(52) U.S. Cl. 340/686.6

(57) ABSTRACT

Embodiments of the invention may include a sensor system and a method used to track the behaviors of targets in an area under surveillance. The invention may include a sensor array located in the area that is capable of sending messages to a user when behavior of a tracked target is determined to be anomalous. In making the determination of anomalous behavior, the sensor system and method may generate and continuously refine a pattern of life model that may examine, for example, the paths a target may take within the sensor array and the end points of the paths taken. The sensor system and method may also incorporate any user defined conditions for anomalous behavior.

### FIELD OF THE INVENTION

Embodiments of the present invention relate to tactical awareness sensor systems and, more particularly, to sensor arrays which automatically determine and use pattern of life data.

### BACKGROUND OF THE INVENTION

Recent developments in sensor array technology have enabled advancements in distributed sensor networks or systems used for surveillance of areas, such as public spaces, parks, and building complexes among others to identify potential threats. These systems may consist of a series, in some cases thousands, of remote units, often referred to as ‘motes’. These units may comprise a battery, radio, processor, storage and sensor packages, which allow them to operate independently. When spread over an area, the motes can form an ad-hoc network, communicate between themselves, and relay data from their sensors back to a base station for analysis. As an example, a MSP410 Mote Kit remote sensing unit, manufactured by CrossBow Technologies Inc. in San Jose, Calif., may be used in one of these ad-hoc networks.

These systems distinguish themselves from earlier heavyweight unmanned ground sensors by vestige of the basic systems structure. These systems no longer require a direct connection between each sensor and a central point and the data analysis can be performed sensor by sensor. Modern remote sensor units may be configured to pass data between themselves, act locally, use each other to route data and communicate, and may function to form far more scaleable and robust sensor systems.

When deployed in a military or surveillance environment, these earlier unmanned ground sensor systems and even modern remote sensor systems have proven difficult to use in practice, especially when deployed over wide areas or in areas of heavy traffic. Typically, intensive setup is required to configure a system, including collection of background data and setting up specific triggers and alarms. This process often requires study and analysis of data collected by the systems about a given location, a process that often takes significant upfront investment in time and resources. Earlier systems also exhibited limited detection capability, minimal or no tracking or classification ability, no sharing of information between the sensors, and no feedback about whether specific detections were of interest to a user. Often, these systems served only as data collection devices for a remote user, who then personally interpreted all the data and sensor detections to analyze the results locally. Additionally, the setup process, including the intensive study and analysis of collected data, must be repeated when circumstances change, the system is moved, or if different triggers and alarms are desired. The fact that the system is made of individual systems did not allow for higher level functioning.

Previous attempts at sensor surveillance systems include commercial systems manufactured by CrossBow Technologies. These commercial systems involved unmanned ground sensor systems tried by the militaries of the United States and Great Britain since the 1970s.

### SUMMARY OF THE INVENTION

As sensor systems continue to evolve and advance, the ability to identify and locate targets has improved, providing greater processing, communication range, and bandwidth. However, even with improvements in complex target detection, analysis, and positioning, the previous systems discussed above still require intensive setup and monitoring to make the systems effective at selecting some targets as threats and to ignore other targets. In the military and surveillance arenas and in many other non-military arenas, sensor systems may experience frequently changing operating conditions or locations, wherein every change to the system requires labor intensive procedures and long setup times before the sensor system is functioning or useful.

Embodiments of the invention include a method and a system for determining anomalous behavior of targets within an area under surveillance by a sensor array. The sensor array may be configured to detect both the movement of a target and the path that the target takes through the sensor array. The movement of the target and the path taken may be compared with a pattern of life model to determine whether the movement or the path taken is anomalous. Once determined that the behavior of the target is anomalous, a user may be alerted.

### BRIEF DESCRIPTION OF THE DRAWINGS

FIG. 1 illustrates an example of a system in accordance with an embodiment of the present invention.

FIG. 2 illustrates a hypothetical mission for a sensor system deployed to track targets and relay messages to deployed soldiers.

FIG. 3 illustrates an architecture of a processing model in a sensor system in accordance with an embodiment of the present invention.

FIG. 4 illustrates an example of a sensor that could be used as a part of an array in a sensor system in accordance with an embodiment of the present invention.

FIG. 5 illustrates a sensor system in accordance with an embodiment of the present invention.

FIG. 6 illustrates an example to determine the nearest neighbors of a sensor in accordance with an embodiment of the present invention.

FIG. 7 illustrates a generation of virtual nodes around a single sensor in accordance with an embodiment of the present invention.

FIG. 8 illustrates paths in time of three targets through a sensor system in accordance with an embodiment of the present invention.

FIG. 9 illustrates an example of a histogram of a limited network of sensors and the various weights of the transitions between nodes in accordance with an embodiment of the present invention.

FIG. 10 illustrates an example of a tree structure originating from a starting node in accordance with an embodiment of the present invention.

FIG. 11 illustrates a link by link pattern of life message in accordance with an embodiment of the present invention.

FIG. 12 illustrates a pattern of life path message to represent a path through a sensor array in accordance with an embodiment of the present invention.

FIG. 13 illustrates the paths contained in a message shown in FIG. 12 and the organization of the data to reconstruct the target behavior in accordance with an embodiment of the present invention.

FIG. 14 illustrates an operation of a simplified tracking system in accordance with an embodiment of the present invention.

FIG. 15 illustrates tracking of a target moving through a sensor array in accordance with an embodiment of the present invention.

FIGS. 16 and 17 illustrate the operation of a link by link detection mechanism as a target moves through a sensor array in accordance with an embodiment of the present invention.

FIGS. 18 and 19 illustrate the operation of a prediction based detection mechanism as a target moves through a sensor array in accordance with an embodiment of the present invention.

FIGS. 20 and 21 illustrate the operation of an end to end detection mechanism as a target moves through a sensor array in accordance with an embodiment of the present invention.

FIG. 22 illustrates a neural network approach to a sensor system in accordance with an embodiment of the present invention.

### DETAIL DESCRIPTION OF THE INVENTION

Embodiments of the invention may include a sensor array system or surveillance system that employs a pattern of life architecture to automatically build models from historical or real time data and identify behavior in real time that sufficiently differs from the pattern of life model.

Sensor array systems may include distributed systems, ad-hoc networks, and data fusion systems that maybe used surveillance systems and other systems, such as traffic control systems, ground monitoring sensor systems, and remote targeting systems. In accordance with embodiments of the invention, commercial off the shelf (COTS) remote sensors may be used to deploy large inexpensive COTS systems. Reductions in sensor costs over recent years has made COTS and other systems feasible that spread hundreds of remote sensors over a target area and monitor a large area using the remote sensors. As an example, embodiments of the invention may be used to configure and use these types of sensor systems for surveillance and situational awareness.

Although many different types of applications of embodiments of the invention may be developed, embodiments of the invention are described herein with reference to a military application and the surveillance of a mission target area. For example, an embodiment of the invention could include the deployment of a sensor array system in an urban/semi-urban setting prior to a military mission or during a peacekeeping operation. Without a sensor array system, the area under surveillance would typically be limited to line of sight, which is often limited by the buildings and roads in an urban setting. Even when supported by a unmanned aerial vehicle (UAV) or other aerial support, the ability to monitor a large target area may be very difficult without a sensor array system.

A sensor array system in accordance with embodiments of the invention may be configured to accomplish two broad objectives. Firstly, the system may observe a specific target within an area and alert a user when the target is present. Secondly, the system may monitor the area for all threats, known or unknown, in an urban setting and allow users to see and respond to what is going on around them.

Within this setting, the system, in accordance with an embodiment of the invention, may include several characteristics that could be useful in a military or tactical awareness application. For example, the system may include the ability to detect targets moving near them, track targets through the environment, identify target types as to their class (such as a car, truck or person), gain an understanding of what the local environment looks like, have sources to visually confirm targets of choice, avoid being surprised by target(s) or their behavior, be able to react as and when certain conditions are met by the targets' behavior, be able to supply this data to other users or team members, be able to use other assets to detect and track the target, see friendly force information and location, be able to discriminate neutral and hostile targets, allow targets to be dealt with from a distance, remain mobile and retain flexibility regarding responses, and rely on as few sources of information as possible to satisfy all of the above.

To accomplish some or all of the above system characteristics, sensor array systems in accordance with embodiments of the invention may employ a pattern of life system that uses the information from deployed remote sensors. This information may include information about detections, classifications and tracks of targets. This information may be configured to allow the system to construct a model of behavior of targets moving in the network, together with metrics that show the probabilities associated with these movements. Once the probabilities are established, this pattern of life model may be used as a basis of comparison for new target tracks, the comparison providing the system an idea of the nature of the target's movement. If the target is identified as anomalous, then the system may command other sensory assets to gather information, as well as alert the system users and perform any other function needed by the users.

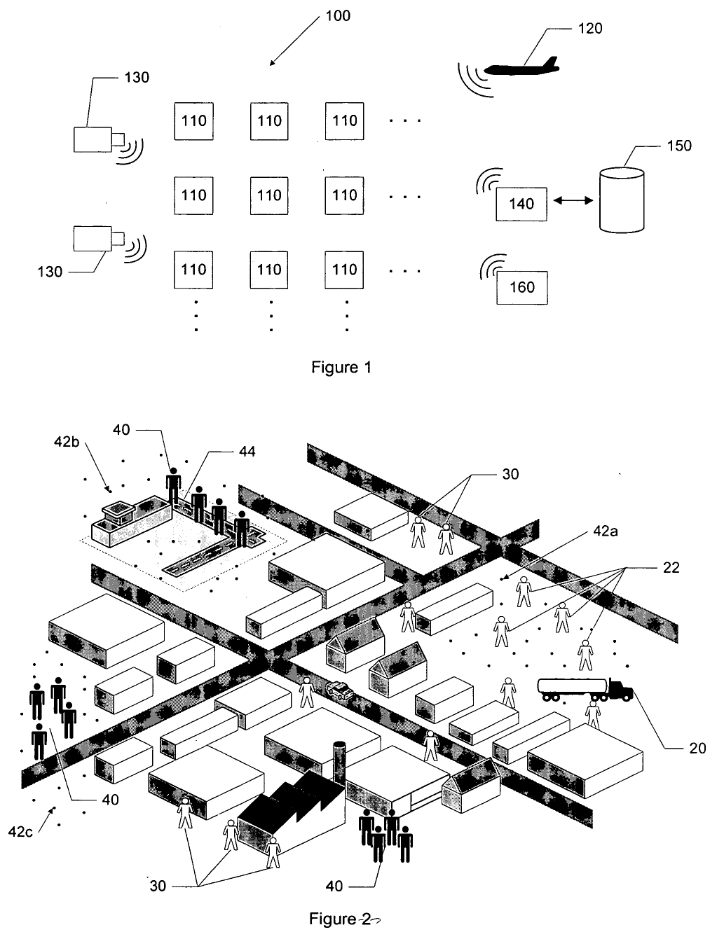

FIG. 1 schematically illustrates an example of a sensor array system in accordance with an embodiment of the invention. The system 100 includes an array of sensors 110, a UAV 120, cameras 130, a central processor 140, and a database 150. Information gathered and collected by the sensors 110, the UAV 120, and the cameras 130 may be transmitted to the processor 140 and the database. The database 150 may be distributed across the network. Although not every element in FIG. 1 is necessary to develop a working system 100, the system 100 and the pattern of life model generated from collected data may be used in connection with any number of sensors packages and surveillance systems, for example, the MSP410 Mote Kit produced by CrossBow Technologies Inc. in San Jose, Calif. Once data from a sensors 110 begins arriving at the processor 140 and the database 150, the processor 140 may be configured to start building the pattern of life model and begin alerting a user to any detected anomalous behavior. The more data received by the sensors 110 over time, the greater fidelity the processor 140 can generate in the pattern of life model.

Due to the increase in processing power and distributed networking advances, the processor 140 and the database 150 may be incorporated directly into the distributed network created by the multitude of networked processors in each of the sensors 110. Each of the sensors 110 may also be configured with individual processors to form a distributed sensor array capable of locally storing and processing a pattern of life relevant to the individual sensor and its neighbors. Messages between neighboring sensors may keep the patterns aligned and notify the user of target tracking through the network. A user terminal 160 may be configured to convey to a user information that tracks targets through the network of sensors.

As an example of how a sensor array system in accordance with the invention could be deployed, FIG. 2 illustrates a hypothetical mission for a sensor system deployed in a village in an area of conflict where the environment would require many of the above system characteristics. In this example, a squad of soldiers 40 may be tasked to monitor an area 42a for selected targets. In this case, the target may primarily include a truck 20 and hostile individuals 22. The mission may include monitoring the truck 20 and the individuals 22 until the circumstances present an opportunity to move in and apprehend a specific individual and remove them from the target area 42a along an exit route 44. Exit route 44 may have an area 42b with additional sensors. Additional sensors may be configured in area 42c where another squad of soldiers 40 are positioned. Even if the village is not currently considered hostile, the hostile individuals 22 may target soldiers 40 if presented with an opportunity. Complicating the environment, civilians 30 may be mixed in and around the village, possible even in the target area 42a.

In addition, the civilians 30 in the village may detect the squads 40 approach and telegraph this information to the enemy targets 20 and 22, either deliberately or by their actions. Either way the enemy is therefore forewarned and can prepare to fight or disperse. If the soldiers 40 are unable to detect this in advance or during a mission, the enemy targets 20 and 22 could quietly split up, reposition in the village, and possibly prepare an ambush along the predicted line of retreat without the soldiers 40 knowing. In such a situation, when the soldiers 40 arrive at the target area 42a, the targets 20 and 22 may be long gone, preparing an ambush where the soldiers would have to fight and return fire on unequal terms.

This scenario represents the reality of urban warfare and peacekeeping duties. The friendly forces may be limited by response and intelligence and normal life must continue around them. It is this normal activity that can provide excellent cover for hostile forces, who often know the village or city and the culture better than the friendly forces. As a consequence, it is often difficult to notice and recognize patterns out of the ordinary amongst the normal background activity of the local population.

Such a situation presents an extremely difficult environment to monitor using human surveillance or traditional sensor systems. With known prior art systems, the squad 40 may be limited to line of sight information gathering and intelligence. To process the information, human intelligence may be used. However, it can be costly and quickly become obsolete. On the other hand, eyeballing targets without processing the information can be dangerous in a city better known by the enemy. As such, without adequate surveillance, the soldiers 40 may head into the village to apprehend the targets, based on faulty or outdated intelligence. Traditional sensor systems require long set up and deployment times as users must observe the sensor system and manually build a model, included specific triggers, to monitor the target area 42a.

However, with the use of a sensor array system in accordance with the invention, monitoring of the target area 42a, exit route 44, and other parts of the village may allow for setup in much less time, track movement in the village despite the difficulty of the environment, and successfully identify abnormal behavior.

For example, the same mission described above with a sensor array system in accordance with the invention would provide the soldiers 40 with significantly improved intelligence and monitoring ability. Prior to the arrival of the targets 20 and/or 22, the soldiers 40 may deploy a sensor array in the target area 42a and other areas in the village, such as area 42b along the exit route 44 and area 42c. The sensors could ostensibly be deployed during normal patrols of the village. As an example, the sensor array may include multi-modal remote sensors, intelligent cameras and processing capability to build a pattern of life model. Once deployed, the sensor array may be configured to build up a pattern of the comings and goings in the target area, and learn to adapt those normal patterns to the terrain. The majority of the remote sensors, such as the MSP410 Mote Kit manufactured by CrossBow Technologies Inc. in San Jose, Calif., may include passive sensors, small enough to be hidden but capable enough to detect the passage of cars, humans, and trucks. In one embodiment of the invention, cameras may be used with the remote sensors. Additionally, portable UAVs or other aerial surveillance may be added to the sensor array. Orbiting UAVs may also serve as communications link relays between the soldiers 140 and the sensor array network via wireless communications devices.

Connected to the network, the soldiers 40 can receive real time information from the sensor array and receive alerts when abnormal behavior is detected by the sensor array system. With the information from the sensor array system, soldiers can get into position while monitoring whether or not any abnormal behavior has been detected by the sensor array system. If the sensor array system detects abnormal behavior, a series of alerts may be issued. The cameras in the sensor array system may provide still pictures or video of the target area 42a, allowing the soldiers 40 to track the movement of hostile forces and avoid walking into an ambush. If no abnormal behavior is detected, the soldiers 40 can launch a surprise mission knowing that they have secured the element of surprise. Additionally, once the soldiers 40 have completed their mission and are exiting through the exit route 44, the sensor array system may be used to monitor movement in other parts of the village and alert the soldiers if they are being followed or approached from different directions. Additionally, sensors along the exit route can provide advanced notice of an ambush ahead, allowing the soldiers an opportunity to chose a different route.

If the enemy flees, the soldiers 40 may also maintain their understanding of the target area 42a through the sensor array and identify the flight of the enemy. This may also allow the soldiers 40 to verify where the higher value targets are going while ignoring low value targets that pose little threat. In such a situation, the ground sensors, cameras and the UAV may be configured to collaborate to distinguish higher priority targets from lower priority targets.

Sensor array systems in accordance with the invention may be configured to develop a pattern of life model with minimal to no input from the user. This pattern of life model may determine the normal patterns of the comings and goings in an area populated by friendly, neutral and hostile forces. Once the pattern of life model is developed in sufficient detail, anomalous behavior can be detected, tracked and responded to.

The pattern of life model may be configured to increase a user's awareness of his surroundings by generating nodes to sense objects not directly in the line of sight of the user. The pattern of life model may also allow the sensor array system to alert the user to abnormal behavior without the user constantly watching a display screen. Instead, the sensor array system may be configured to learn, as time passes, a neighborhood's rhythm and pattern of life, such that the system will track classify and analyze each and every target it finds. As explained in greater detail below, data collected by the sensors may be used in real time to monitor a target area and may be incorporated into the pattern of life model, constantly improving the fidelity of the model.

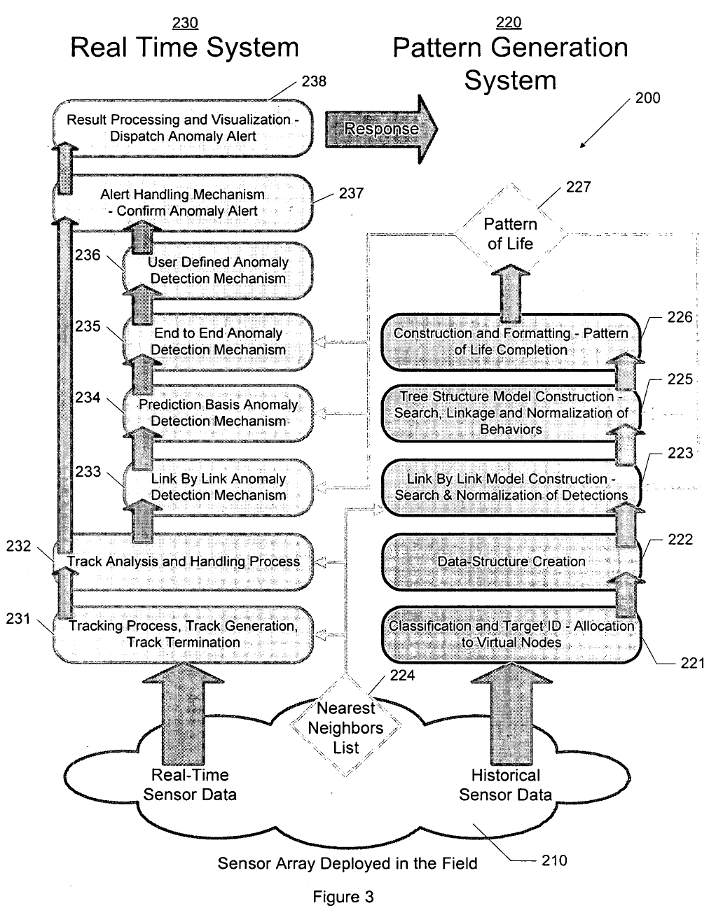

FIG. 3 schematically illustrates a possible architecture 200 of a pattern of life model implementation in a system 100. The architecture 200 may include an array of sensors deployed in the field as represented by 210. The system 100 may communicate using wireless technology or other known communication technologies with two systems: the pattern of life model system 220 and the real time tracking and alerting system 230. Although the pattern of life model system 220 and the real time system 230 are discussed herein as separate, the systems 220 and 230 may be performed on the same or separate hardware by one or more processors, hardware or software. For example, the processor 140 and the database 150 shown in FIG. 2 may be used to run both systems 220 and 230.

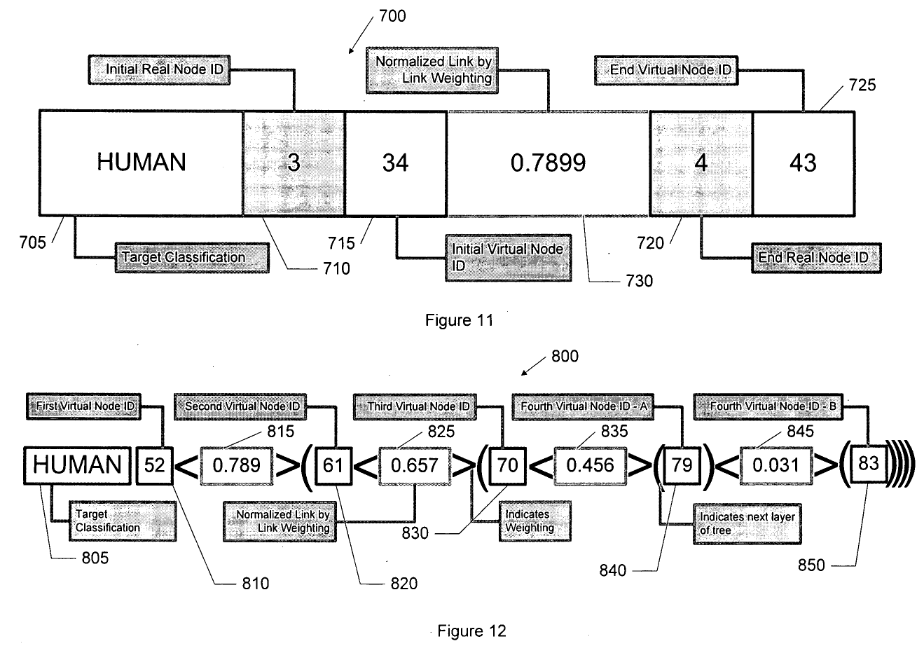

During use, the data collected by the sensor system 210 is provided to pattern generation system 220. The sensor data is initially passed to box 221 where the pattern generation system 220 classifies target data according specific sensors and/or virtual nodes. Additionally, any identified target may be given an identification number for purposes of tracking the target through the sensor array. In box 222, a data structure is created. The data structure may include the embodiments as shown in FIGS. 11 and 12, discussed below. In box 223, a link by link model may be constructed, as discussed in greater detail below.

Information related to a nearest neighbor list 224 may also be provided from the sensor array 210 to the system 220. The nearest neighbor list 224 may be used in box 223, along with the sensor data, to develop the link by link model. The link by link model refers to the process of assessing the frequency of target movement between individual sensor detections. For a target moving between nodes A and B the link by link system will classify that movement as belonging to that link and this will form one element of the weight assigned to that link. Unlike tree based pattern analysis, the link by link system does not consider the targets behavior before or after the transition in question. As such the link by link analysis lumps all similar movements together and gives an idea of the frequency of occurrence of that movement irrespective of other characteristics of the target other than class. The nearest neighbor list may be compiled in multiple ways. For example, the nearest neighbor list may be manually configured by the user. Alternatively or in addition, the nearest neighbor list may be worked out on the basis of a model that uses the detection ranges and the positions of the sensors to determine which sensors are neighbors. And also separately or together, the nearest neighbor list may also be determined when the sensors can geographically locate themselves and share data, in determining among the sensors who is a neighbor of whom.

Next, in box 225, the system 220 may configure the sensor data from the sensor array 210 into target path or tree structure model representing the paths through the sensor array that each target takes when it enters the sensor array. The target path model and the link by link models may then be constructed and formatted into a pattern of life model in box 226. Once the pattern of life model is created, the system 220 may distribute the pattern of life model at box 227 back to boxes 223 and 225 where the fidelity of the pattern of life model may be improved as new data is continuously collected by the sensor array 210. The pattern of life model may also be distributed to the system 230. The system 220 may be configured in alternative ways. For example, the box 225 and the generation of the target path model may take place before the link by link model construction in box 223.

In this example, the real time system 230 receives sensor data from the sensor array 210. Box 231 begins the process of analyzing the sensor data by determining track process, track generation, and track termination. The analysis can include determining the entry point where a target entered the sensor array 210 as well as the track the target is taking through the sensor array or where the target has stopped. For example, in box 232, the system 230 may perform track analysis and handling processes, such as: identifying which tree in the pattern of life relates to the current target; handling the creation of new tracks and the deletion of old tracks; and managing data passed to the graphical user interface (GUI) of user terminal 160, including position, track ID number, and classification. The sensor data and the analysis may then be passed to both box 233 and box 237.

Boxes 233, 234, and 235 are configured to analyze the sensor data to identify whether or not a target is exhibiting abnormal behavior. Box 233 may be configured to analyze target movements by a link by link detection mechanism, which is discussed in greater detail below, using inputs from the pattern of life model distributed from 227. Box 234 may be configured to analyze target movements on a prediction basis (generated by the pattern of life model) or by a target path detection mechanism, which is also discussed in greater detail below, using inputs from the pattern of life model distributed from 227. Box 235 may be configured to analyze target movements on a end to end detection mechanism, which also is discussed in greater detail below, using inputs from the pattern of life model distributed from 227. Additionally, box 236 may include user defined anomaly detection analysis when a target violates a user defined boundary or other condition. User defined conditions could include zones to trigger on movement of a vehicle, human or both. Another user defined condition could include zones to trigger on movement crossing a line, either from entry or departure of an area. Additionally, a user may define a zone to suppress alerts, such that the area in question generates no alerts; for example, the soldiers 10, tracking targets 20 and 22, would want to suppress an alert if sensors in that area would recognize the entry of soldiers 10 as anomalous.

An alert handling mechanism, box 237, may receive alerts of abnormal behavior from any of boxes 232, 233, 234, 235, and 236. The alert may undergo additional analysis to confirm the alert or analyze the alert in the broader context of the sensor data received by the sensor array 210. This analysis may be related to the overall threat level set by the user. For example, in a high threat environment, the user may want to see all anomalies in order to gauge the threat level in that environment. On the other hand, in a low threat environment, the user may only want to see those threats that represent the most significant anomalies. The alert handling mechanism of box 237 may be configured to assess the significance of each anomaly and control the order of evaluation of the alerts, so that precedence for user defined alerts is maintained. Finally, box 238 performs results processing to determine whether issuing an alert is necessary. It is also possible for the system to prepare visualization information to accompany the alert, for example camera images or video of the area where the alert was generated from. The response from the real time system 230 may be configured to distribute the alert to a single user or to a large number of users or individuals in the target area.

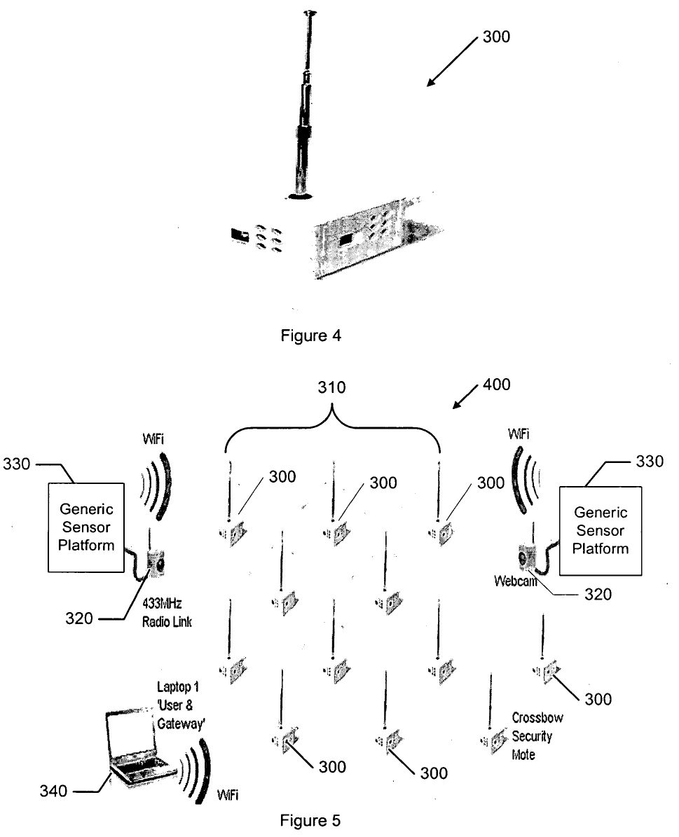

The sensor array 210 from FIG. 3 may include many different types of sensors and detectors suitable for a tactical situational awareness system or surveillance system. For example, the sensors may include one or more of the following types of sensors: acoustic, electromagnetic spectrum, seismic, vibrational, magnetic, radar, lidar, IR illumination, ultrasonic, beam-breakers, x-ray, laser, microwave, video, audio, and other rich sources. In one embodiment of the invention, the sensors are small devices containing a wireless radio, processor board and a sensor package. FIG. 4 illustrates an example of a sensor by CrossBow Corporation, in San Jose, Calif., that could be used in connection with a sensor array in accordance with the invention. The sensor 300 may include a wireless radio, processor board, a magnetometer, and four passive infra-red detectors, one on each side face of the sensor, for example. The infra-red detectors may include a 90° arc view looking out the side of each face of the sensor. This allows the sensor to detect near and far targets in the infra-red domain, such as humans or vehicle engines, and to detect nearby movements of ferromagnetic materials, such as cars, doors, or if very close, humans carrying metallic objects. Additionally, remote cameras may be integrated into the sensors or separately positioned in the sensor array and connected to the network. The plurality of sensors 300 may be configured to form an ad-hoc sensor network, communicating to each other and through each other to relay information to different parts of the sensor network, such as a user platform or the like.

FIG. 5 schematically illustrates a sensor array 310 made up of sensors 300, as shown and discussed with respect to FIG. 4. The sensor array 310 may also include cameras 320 connected to generic sensor platforms 330. A sensor platform 330 may include a generic processing unit/device or other inexpensive software/hardware platforms capable of supporting and transmitting images from a camera 320. The sensor platform 330 may also include cameras with integrated wireless communication mechanisms. The camera 320 may be an Axis 213 PTZ camera, manufactured by Axis Communications AB in Emdalavägen, Sweden, for example. The sensor array shown in FIG. 5 also shows a laptop 340, which may serve as a user platform or as a processor and database for running the sensor array architecture and pattern of life model. It is contemplated that the laptops 330 and 340 may be configured in a distributed network using an ad-hoc wireless network to collectively run the sensor array and the pattern of life model. Likewise, it is contemplated that the sensors 300 themselves may be configured with sufficient processing power and memory to act as a neural network, allowing the sensor array 310 itself to run the system and the pattern of life model.

The sensors 300 may be configured to be very basic, as discussed above. However, it is also contemplated and feasible that the sensors 300 may use many other sensor modalities. For example, the sensors could include sensor devices in the electromagnetic spectrum listed above already or devices capable of detecting vibration signals, using acoustic sensing or seismic sensing. The sensors may be designed to supply the system and the pattern of life model with a location and time for a target and may be configured to track and classify the target in real time. Indeed, in accordance with embodiments of the invention, the entire sensor array system and the pattern of life model may be configured to allow any number and type of sensors to be incorporated. In this regard, both active and passive sensors may be used. In fact, simple area detection sensors may be employed in numbers such that they are as good or almost as good as other more sophisticated sensors which supply additional information, such as a distance and direction between a sensor and a target. Even when a sensor provides simple target data, such as a simple sensor target localization within a 90° field of view only, the sensor array system 310 may be configured to determine useful information, such as speed, position or range from the interplay between sensors. Additionally, the totality of the data being received from the sensor 300 outputs may be analyzed as discussed in detail below.

More specifically, a target moving through the sensor array 310 may be tracked using a tracking algorithm that uses sensor readings to track targets through the sensor array. The system 310 may also track targets of a particular class, such as individual or vehicle, by using sensor readings from adjacent sensors. The sensor data outputs from adjacent sensors may be tracked by building up a chain of sensor readings associated with the same target. Referring back to FIG. 3, the chain of sensor readings collected by the sensors in the sensor array 210 may be provided to the real time system 230 and the pattern of life model system 220.

In FIG. 5, the sensors 300 and the sensor array 310 may represent a typical deployment of a sensor system 400 in accordance with embodiments of the invention. The sensors 300 may be deployed across a target area and, once turned on, form an ad-hoc wireless multi-hop network relaying data back to any user, such as one or more laptops 340. Once the network is connected, the sensors 300 and the cameras 320 may detect targets using all their sensors and return the time, location and sensor information back to the central user(s) for analysis. The system 400 may allow the sensor array to cover a large area with a few sensors 300 and notifies the user where sensor activations are occurring.

Once data packets from the sensors in the sensor array 310 are received, the data packets may be processed by a laptop 340 or other such processors known to those of skill in the art. The data packets may then be passed into the architecture system 200 shown schematically in FIG. 3. In one embodiment, the data packets may be sent to the real-time tracking system 230 for display on a laptop screen and for comparison to the pattern of life, looking for anomalies. Additionally, the data packets may be sent to the pattern of life model system 220 where the data may be collected by a pattern generating code for the pattern of life model and ultimately included in the pattern of life model used by the system 230.

It is contemplated that the pattern of life model could be generated from historical data, for example by applying the architecture shown in FIG. 3 to data accumulated by an existing sensor array system. The historical data from the existing system may be used to generate a pattern of life model that could then be compared to the real time data. Alternatively, the pattern of life model may be immediately applied to a newly deployed sensor array system, where the pattern of life model is built from the real time data received from the sensor array over time. In such a situation, each new data packet received from the sensor array increases the fidelity of the pattern of life model and increases the ability of the real time system 230 to identify anomalies occurring in the sensor array 310.

In an embodiment of the invention, the pattern of life model system 200 may include the pattern of life model generation system 220 and the real time system 230, as shown in FIG. 3. In generating a pattern of life model, the system may process the data received from the sensor array 210 to determine the assumptions that (at a minimum) are needed to describe the actions and behaviors of targets within an area. The pattern of life model generated by the system 220, either as a standalone application applied to historical data or as a real time application, produces a model of the environment and the behaviors of targets that is used as the basis of comparison for the rest of the system.

The pattern of life model system 220 may derive location, identification, and classification from the raw sensor data. A user at the laptop 340 in FIG. 5, for example, may receive data from a sensor containing the sensor's ID, location, sensor reading, and sensor measurements, including time of detection. This data may be compiled into a geo-spatial and temporal block and used as the basis for the analysis of the pattern of life model system 220.

In accordance with one embodiment of the invention, the sensor data collected from the sensor array 210 in FIG. 3 may be analyzed by using the nearest neighbor rule. This rule takes the sensors and assigns unique identification numbers to them that are indicative of their spatial location. The unique identification number, expressed in table form, indicates the nearest sensor nodes to one sensor. This spatial origination is created such that a target, if tracked, should appear at a sensor's neighboring sensor node before it reaches the sensor, then appear at the specific sensor, and then appear at another neighboring node as the target moves through the sensor array. This nearest neighbor rule may be configured using the overlap in coverage of sensor nodes. The use of overlapping sensor coverage may be used to employ cooperative data fusion and may operate much like a network routing table would express it for data packets being communicated from one router to the next. Although it is not necessary, the sensor nodes may be organized relative to each other in space, allowing for an easily interpretable view for human analysis. When two sensors with overlapping coverage sense the same target, the overlapping area may be used as a virtual node, providing greater fidelity of the sensor array 310 by using data from multiple sensors 300 at once.

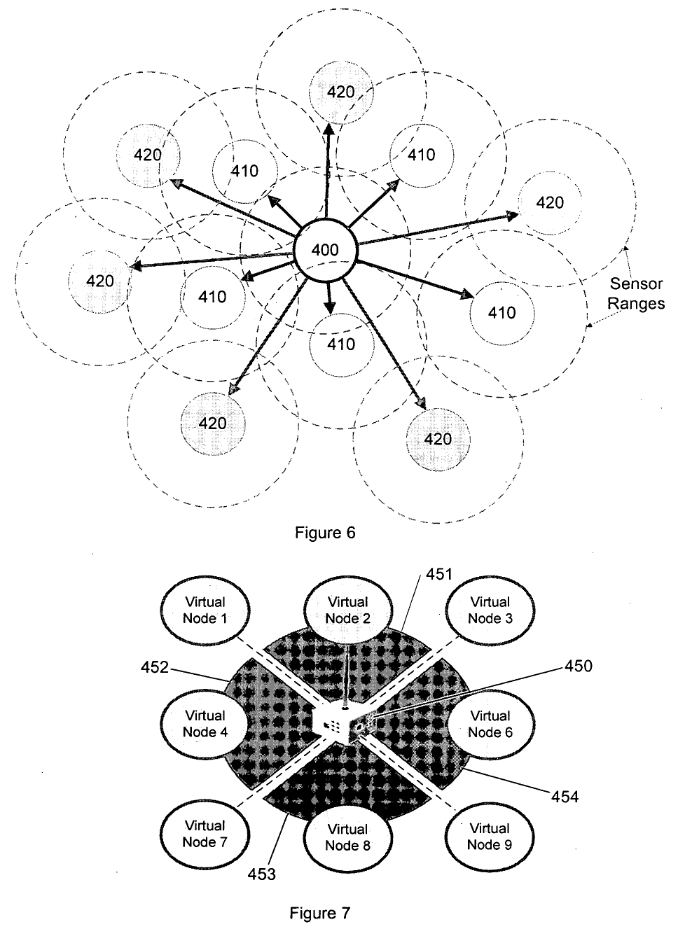

FIG. 6 schematically illustrates sensors 400, 410, and 420 and their respective sensor ranges. FIG. 6 also shows how a nearest neighbor table could be generated. Sensor 400 includes five nearest neighbors 410, which are nearest neighbors because they represent the closest sensor nodes, or sensor ranges, to the sensor 400. Sensors 420 do not constitute the nearest neighbors of sensor 400 because, in order to go from sensor 400 to sensor 420, the movement must pass through the node of sensor 410. The same analysis may be performed on every sensor in a sensor array, identifying the nearest neighbors for each sensor in the system.

In a deployed sensor array system as shown in FIG. 6, the nearest neighbor rule table could be compiled locally by sensor nodes during the establishment of the network and communicated to a user along with the location data of the sensors. A compiled table of nearest neighbors could contain every possible path a target could take through the sensor array.

With the sensors connected logically, the sensor readings may be analyzed. For example, a sensor detection may be classified as to the modality of detection, such as whether or not a infra-red detector or magnetic detector was activated. Such information may be used to determine whether or not a human or a vehicle is passing through the sensor array. It should be understood that many other types of classifications could be detected and generated depending on the types of sensors used and the types of classifications available. Multiple ways of classifying targets are known to those of skill in the art.

With location and class determined for any single sensor, the target range and or bearing may be determined by analyzing sensor data from neighboring sensors. FIG. 7 schematically illustrates how virtual nodes may also be generated around a single sensor. Sensor 450 may include virtual nodes 1-9. For example, a single sensor 450 may include four separate infrared detectors with fields of view 451, 452, 453, and 454. When a target falls within two fields of view, the sensor can report the target is at a particular virtual node. For example, if a target is within fields of view 451 and 452, then the target location may be assumed to be virtual node 1. Alternatively, if a target only falls only within one field of view, for example field of view 453, then the target may be assumed to be at virtual node 8. Virtual node 5 has been assigned to a magnetic detector, which has no direction. By comparing the movement of a target through virtual nodes, some range and bearing information may be determined about a target using only a single sensor. It should be understood that virtual node data may be determined and handled like any other sensor data, allowing the sensor to provide some information, such as location and/or time data, at any point that a virtual node is triggered by a target.

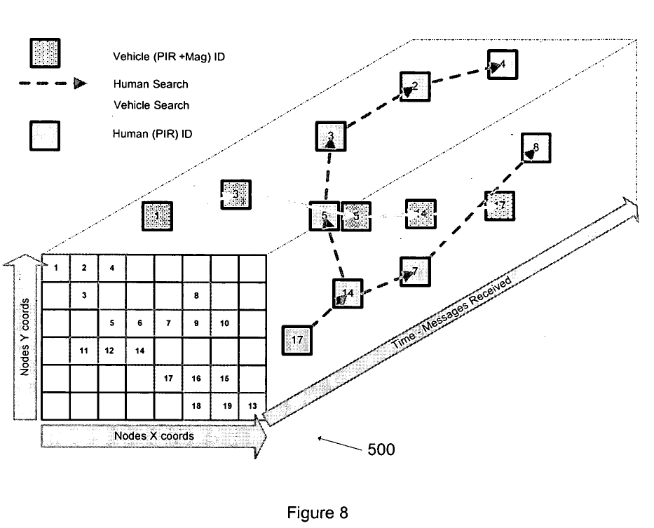

With target detections allocated to a sensor and virtual node, and with all of these detections positioned relative to each other in time and space, the system 100 may be configured to build a 3D data structure of the detection history of the network of sensors in the sensor array. FIG. 8 schematically illustrates the paths of three targets through a sensor array 310 and the sensor detections in a table format. The XY plane represents a table 500 or network of nearest neighbor sensor nodes in a sensor array 310. The area under surveillance may be limited by the nearest neighbor lists, which may depend upon the physical layout of the sensors. At any one time, the XY table illustrates the detection status of the sensor nodes in the sensor array 310. The XZ and the YZ planes show the evolution of the sensor node detections over time.

The data structure shown in FIG. 8 may be deconstructed by an algorithm to process the data and connect likely paths through the data structure for humans and vehicles (or other classifications), generating a pattern of life from the data structure through both a link by link and a tree structure approach. The aim of developing a pattern of life model is to determine the sequence of events representing target behaviors within an environment and to make a judgment as to whether the observed behavior is normal or abnormal.

The data structure collected from the sensor array, in real time or as historical data, may be searched and analyzed to relate the sensor detection data to its nearest neighbors, allowing pattern of life models to be generated from historical data and/or from real time raw sensor data. The data structure may contain clues that outline the comings and goings of humans and vehicles through a sensor array in a town over a period of time. The data structure may also include entire paths through the sensor array.

As an example, the activity of a vehicle will be explored with reference to FIG. 8. Starting at the first square on the table 500 in the XY plane, the earliest time stamp is represented by the numeral 1 in the first box in the upper right hand corner and signifies the event of a sensed target by a given sensor. In this case, the event represents the detection of a car by a sensor in the sensor array located as shown in the table 500. By examining the edges of the box connecting to its neighboring boxes, an event list may be analyzed and generated according to sequential movement through the sensor array. For example, each neighbor's event list is examined in turn for an occurrence of a car object within a defined time-window. In other words, for an event at time t₁, an algorithm may be configured to examine neighbors for t₂ event(s), such that t₁+tₜᵣₐₙₛᵢₜ_{_{—}}ₜᵢₘₑ≦t₂≦t₁+tₜᵣₐₙₛᵢₜ_{_{—}}ₜᵢₘₑ±t_{tolerance}_{_{—}}ₜᵢₘₑ, for example.

If such an event is found, then that edge is flagged as traversed and a recursive call is made for the neighbor reached from that edge. The edge between one event to another may also be referred to as a link. Through recursive exploration of the table 500, a reconstructed path may be determined, comprising the links between events. Once recursion terminates and all neighbors have been examined, the initial event at the starting square is flagged as used, all visited edges have their weights incremented and the visited flags are reset. It may be possible that while the calculations can take on a two-dimensional plane, the calculations can also take place in a three-dimensional manner.

This stage completed, the process is repeated starting from the next square on the board (for purposes of this process, the area capable of being monitored by the sensor array may be broken down into a discrete number of cells according to range). This continues until all squares on the board have been examined. The quantity t₁ is incremented ready for building up the next layer of edge traversal evidence and so on. This continues until t₁ has covered the range of time values for all events logged and a set of edges across the graph that describes the frequency of travel for car/human objects is prepared. Hence, the edge weights can be regarded as a histogram built through an attempt at path reconstruction for a particular class of object. In other words, every time the same transition is made, the weight is incremented by one for that transition (or link). At the end of the process, all weights are normalized against the most frequent transition, for example.

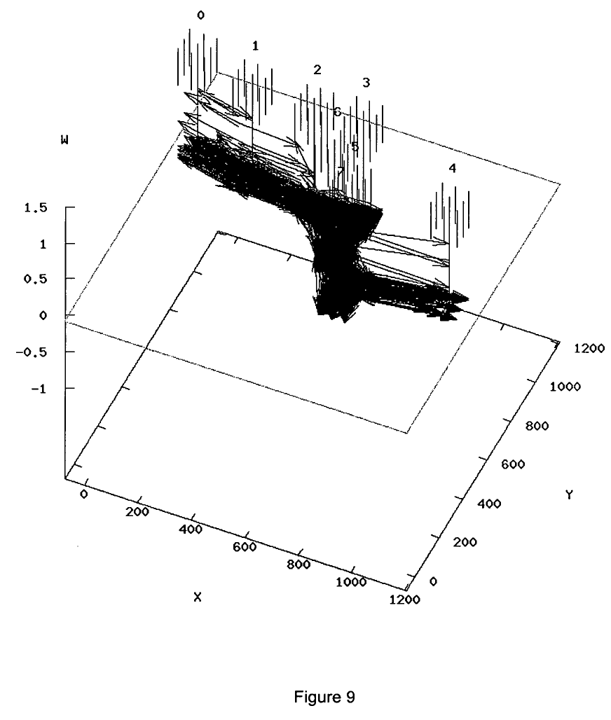

FIG. 9 illustrates an example of a histogram of a limited network of sensors and the various weights of the transitions between nodes shown together at the same time with the physical layout of the sensor array, providing a geographically referenced plot of the links discovered by analysis of the data structure. In the data structure, connectivity, but not position, is shown; so by taking connections discovered in the process and adding the locations of the nodes (and by offset, virtual nodes), the data structure can be positioned in 3D space. The full connectivity with the individual links positioned on the Z axis relative to their weight is shown, such that higher weights appear higher up along the Z axis. At a weight of zero, all connectivity discovered is displayed, and as the threshold is increased, the links drop out, representing those under the threshold. Eventually, at a weight of one, only the highest weighted link (i.e. the most frequent) is present.

As a result of the analysis and proper weighting, all the sensor detections serve to make up a pattern of life that represents normal behavior, or at least behavior that happens at a frequency sufficient to be considered normal. The pattern of life model may be represented by the transitions or links between nodes, virtual or otherwise, and the normalized weight or frequency of those transitions. Therefore, a highly weighted (frequently occurring) transition can be said to be more normal than a lowly weighted (hardly occurring) transition. As one of ordinary skill in the art would appreciate, there may be many potential transitions between nodes for which no transitions or weights will be seen. These will either be potential paths rendered impossible by geography, such as transitions that would require people to pass through walls or other such conditions, or will be highly unusual behaviors that may be immediately flagged as abnormal target behavior.

A pattern of life model that is composed of only node by node analysis may be unable to identify some abnormal target behaviors if the target behaviors on a node by node analysis appear normal. For example, an enemy combatant passing up and down a street may go unnoticed because each transition along the street is consistent with the flow of foot traffic in both directions on the street. As a result, the pattern of life model may also be configured to track targets in a contiguous manner, allowing a target's behavior through the system to be evaluated. Embodiments of the invention may be configured to spot targets and behaviors that are anomalous in themselves but not behaviors that are masked (intentionally or otherwise) by normal behavior.

A system 400 in accordance with an embodiment of the invention may be configured to determine the normality or abnormality of an overall behavior. To accomplish this, targets may be identified and their behaviors incorporated into the pattern of life by evaluating their overall pattern of behavior and their entire path through the sensor array. Consequently, the pattern of life model may be configured to identify each path traveled by all separate targets as the path winds its way through the sensor array 310. The resulting data structure may be collected from the first initial detection, where a target enters the sensor array 310, to the final detection of that target, where the target exits the sensor array 310. In this way, the behavior of a target may be analyzed using additional factors, such as where the target came from, where the target has loitered (and for how long), and other such factors. The entire environment being monitored may be analyzed for activity that would normally not arouse suspicion, but when happening together are abnormal. For example, a loitering individual on one corner may be normal under most circumstances, but may set off an alarm when a car parks one block away and the driver gets out and walks away. By building a pattern of life model based on entire path data in addition to node by node data, the pattern of life model may be used to identify anomalous behavior even if the node by node analysis appears normal.

Building the pattern of life model to include path and behavior data may be performed by two nested loops. The outer loop may define a start-time for a search and extends from the time of the earliest recorded event for a given target through to the latest recorded event for the given target. The inner loop may define the start (virtual or otherwise) node for tracking the target through the sensor data or sensor array. The two nested loops (together with a time-window) may be used to define a recursive search which is performed through this ‘3D’ space (x,y,t).

For example, with a virtual node and time defined, the search routine may look for a local event that has not previously been evaluated. If an event matching the time (within tolerance) and class criterion is found, then the next stage of search is started. Events (within the time window of the current event) associated with all neighboring virtual nodes, in accordance with the nearest neighbor table, may be examined. Similar to the node to node analysis, when an event is identified that satisfies the appropriate time and class, a recursive call is made to that node and the edge joining them has its weight (for that class) incremented. After all neighboring nodes have been examined and (if needed) used as jumping off points for recursion, the event object at the current node is flagged as being used, so it will not be examined again. Thus the edges form an accumulator space, with the edge weights containing votes according to usage. A path through the sensor array and the sensor data can therefore be reconstructed for a given target by following all events that meet the criteria until no additional events are found.

Once a search encompassing the class, range of time and virtual nodes has been completed, a subset of all edges may be determined with weights >0.000, for example. Then searches may be carried out for the remaining classes.

The pattern of life model, including path data and behavior, contains details regarding the various paths that a target can take through the network of sensors, and, perhaps more importantly, captures the behaviors of the targets through the network of sensors when entering the network from a given point. In one embodiment, the output of the pattern of life generation may be a search table based on the target's initial sensor detection, fanning out like a tree, such that every possible route from that initial sensor is represented, together with a weight for each link, and a final weight representing the weighting of the path taken against all possible paths.

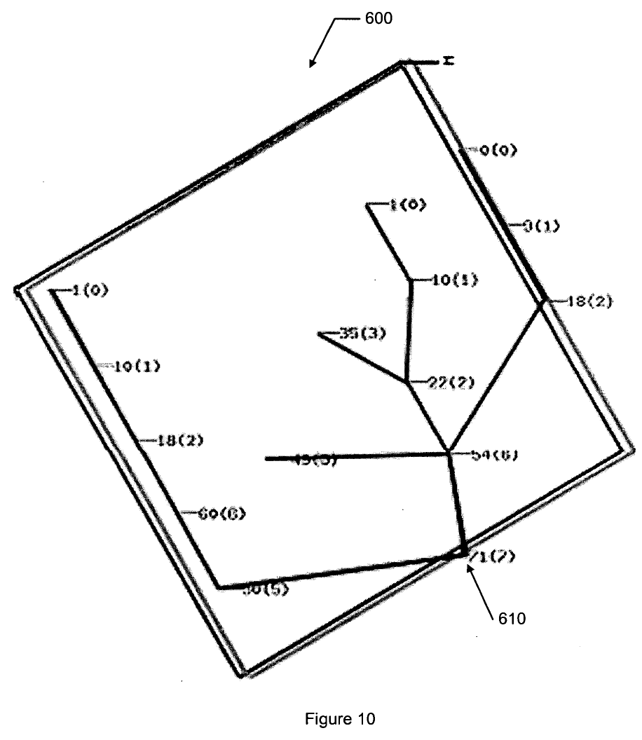

FIG. 10 schematically shows a graphical representation 600 of a pattern of life search table illustrating the various paths traversed by targets entering the sensor network from a starting point 610. FIG. 10 shows a tree structure for one instance of a starting point 610—in this case, node 7 (or virtual node 71). The targets that originate at node 7 then travel through the network as per the branches of this tree. For example, cars or humans starting on node 7 travel typically (as part of normal behavior) to either node 5 or node 6. If the target travels to node 6, then it can go onwards to one of either node 5 or node 2. If the target goes to node 2, the target can then go onwards from there to nodes 1 and 3, eventually terminating at nodes 5, 3, or 0, which are the ends of the tree branches. This diagram can be used graphically by the team to look for patterns known to exist to make sure that the search algorithm is finding the correct patterns. For each of the nodes in the sensor network, there will be multiple branches that represent the paths taken by targets that were initially detected at that node. When aggregated, the various branches give all potential routes for tracks starting on any node. Different branches will reflect separate routes with different weights, even though it is possible that the two different routes may end up at the same end point.

Once the pattern of life is generated and the information entered into a usable format, such as those illustrated in FIGS. 11 and 12, the output of the pattern of life may be received by a real-time, tracking and anomaly detection system or situational awareness system, for example the real time system 230 in FIG. 3. The pattern of life output may be configured to contain several elements. For example, the format of the pattern of life may allow it to be used for the basis of comparison when it is loaded into the real time system doing analysis of sensor data on a link by link basis, as shown in box 233 in FIG. 3. Additionally, the pattern of life output may be used for the basis of comparison when it is loaded into the real time system doing analysis of sensor data on a route prediction basis, as shown in box 234 in FIG. 3. The pattern of life output may also be used for the basis of comparison when it is loaded into the real time system doing analysis of sensor data on an end to end basis, as shown in box 235 in FIG. 3.

FIGS. 11 and 12 show examples of the data structures that may be used to translate the output of the pattern of life into searchable data structures for real time surveillance. FIG. 11 provides generic formats containing the link by link weights, while FIG. 12 provides generic formats containing the tree structure weights. Messages of these data structures are passed from box 227 in FIG. 3, to the corresponding search boxes 233, 234, and 235 to allow the pattern of life to be searched.

FIG. 11 schematically illustrates an example of a link by link pattern of life message 700, which may be output by the pattern of life model. The message 700 may start with a class identification 705, followed by an initial real node ID 710 and an initial virtual node ID 715, indicating a starting location of the target. The message 700 may also end with an end real node ID 720 and an end virtual node ID 725, indicating a end location of the target. The normalized link by link weighting 730 may be located between the initial virtual node ID 715 and the end real node ID 720, for example. The weighting 730 may represent the frequency of observed travel between initial virtual node 715 and end virtual node 725 for the relevant class. The weighting may be scaled against the link with the most frequent travel; for example, the frequency is normalized between 0 and 1, where 0 represents no observed travel and 1 represents the most frequently traveled coupling of nodes. The message 700 in FIG. 11 may be read to represent that the normalized link by link weighting between virtual node 34 and virtual node 43 is 0.7899 for a human.

FIG. 12 schematically illustrates an example of a pattern of life path message 800 representing a path or branch through four nodes of a sensor array. The message 800 may begin with a target class identification 805 and with a first virtual node ID 810, which may represent the initial sensor detection of the target by the sensor array. The normalized link by link weighting 815 may be situated between virtual node ID 810 and virtual node ID 820. The normalized weighting 825 may be situated between virtual node ID 820 and virtual node ID 830. The normalized weighting 835 may be situated between virtual node ID 830 and virtual node ID 840. Finally, the normalized weighting 845 may be situated between virtual node ID 840 and virtual node ID 850. The message 800 may be configured to convey one path through a sensor array which represents the likelihood of moving from one node to another along a path through the sensor array. As shown in FIG. 12, the message 800 conveys the branch or path structure using parentheses and the nesting of weights and node ID's. The message 800 may contain weights representative of the frequency of travel between adjacent nodes, but only for targets that originate at the first node in the tree; as a result, the weights may apply only to a specific path. For all trees in the pattern of life (which represent all target behaviors), there may be multiple transitions between similar nodes found for targets that originated at different nodes. The addition of these transitions may result in the link by link weights, for the tree weights are the link by link weights separated out on the basis of different origin nodes for targets.

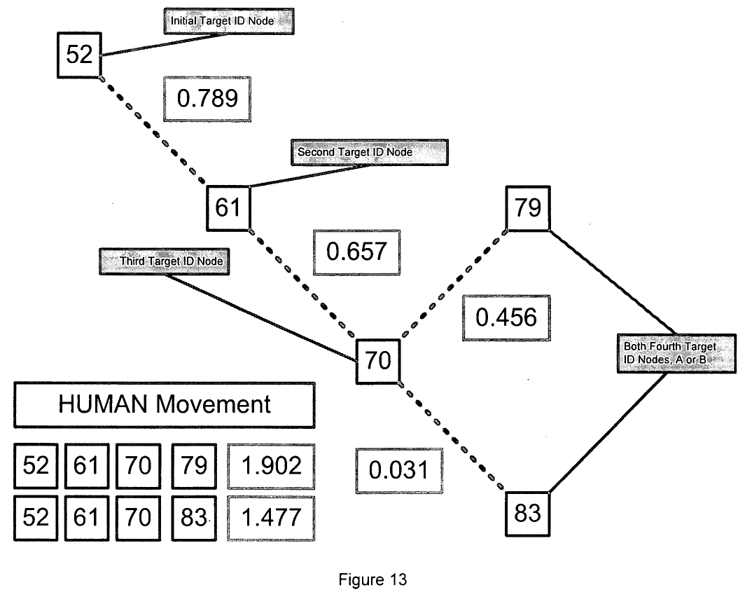

FIG. 13 illustrates the paths contained in the message 800 shown in FIG. 12 and shows how the data may be organized for the reconstruction of target behaviors and encapsulates all the routes identified for targets of a particular class originating from the initial node ID, in this case node ID 52. FIGS. 12 and 13 illustrate the two paths for human movement through a limited example of a sensor array when the human starts at initial target node ID 52. In this limited example, the first path leads from node ID 52, to node ID 61, to node ID 70, and finally to node ID 79. The second path leads from node ID 52, to node ID 61, to node ID 70, and finally to node ID 83. The normalized weights between each of the nodes is shown in FIG. 13. By adding up the normalized weights found in the message 800 in FIG. 12 (which are displayed in FIG. 13 for convenience), the first path has a value of 1.902 when arriving at node ID 79 and the second path has a value of 1.477 when arriving at node ID 83. It should be understood that the message 800 may include large numbers of node IDs and normalized weights representing all the various paths through a sensor array.

The link by link messages for a given node ID and a given path through the sensor array 210 may be used by the real time system 230 in FIG. 3 to compare pattern of life behavior observed by the system and actions taken and observed by a specific target being tracked through the system. Moreover, the information, as shown as an example in FIGS. 11, 12, and 13, may be used by the real time system 230 to determine whether the behavior of a specific target is anomalous.

The objective of the pattern of life model, as stated above, is to organize the comings and goings, or general movement, of targets in an area populated by friendly, neutral and hostile forces, such that anomalous behavior can be detected, tracked and responded to. Once the pattern of life model is generated, the real time system may be configured to allow a user to be alerted to anomalies when they occur. It is also contemplated that once an anomaly has been identified, the sensor array system may further track a target using the sustained contribution of other sensory assets, such as other sensors or cameras that may be activated in response to an anomaly alert. The real time system may be configured to keep a user constantly informed, so that whatever action is necessary, the user will be as informed as soon as possible.

In one embodiment of the invention, the pattern of life model system 220, shown in FIG. 3, may provide the messages, such as those shown in FIGS. 11 and 12, which represent the pattern of life model developed from the collection of data from the sensor array. As shown in FIG. 3, the pattern of life model system 220 may provide messages to the real time system 230, and specifically to boxes 233, 234, and 235, as an example. Although the systems are shown as separate in FIG. 3, it is contemplated that the systems 220 and 230 in FIG. 3 may be implemented using the same hardware and/or set of code. Advantages to this arrangement may include real-time updating of the pattern of life, such that newly discovered target tracks can not only cause an alert, but can also be added to the pattern. The pattern adds fidelity in real time, rather than being a static pattern. Upon receipt of messages from the pattern of life model, the real time system 230 may disassemble the messages in order to apply the proper pattern of life data to a sensed target.

Upon targets being sensed by the sensor array, targets may be classified and displayed with their classification on a screen in a manner understood by those of skill in the art. For example, a user may be able to watch a laptop 340 screen on which targets sensed by the sensor array 310 are displayed along with their classification. It is contemplated that the live sensor data and the pattern of life data may be overlaid onto a map or other geographical representation of the environment of the sensor array, which will often display such features as roads, buildings, etc. Such reference information can be useful for purposes of orientation while users are using the system.

By analyzing the arrival times or sequence of messages, the real time system can track potential targets through the network. For each potential initial target detection, for example when a target enters the sensor array for the first time, the real time system starts a new track. This track exists at time or message number t. Subsequently, after time or message t+x, multiple messages will arrive from sensors all over the network, some of which will be false alarms, some of which will be detections of the same or other targets. Of all the messages received after time t+x, the real time system needs to determine which detections apply to the sensed target and which are false alarms or data received for a different and separate target elsewhere in the sensor array. Messages may be of two types: one from the pattern of life representing the historical data; and the other from the sensors to indicate target detection. The pattern of life model is first constructed from the real time messages indicating target detection, and the pattern of life messages enable searches of targets. The real time messages are used to detect targets through the network. While these two types of messages are described, others may be possible. It is at this point that the logic of the nearest neighbor tables may be implemented to constrain the system for the pattern of life messages. The logic is based on the assumption that within the network, a sensed target may only move between the sensor zones of nearest neighbors. Therefore, the next detection of the target will either be absent from the message stream, or will be a detection of an identical type from one of its nearest neighbors.

The nearest neighbor tables may be obtained in different ways. One way is for the user to manually configure the nearest neighbor tables. A second way involves obtaining the nearest neighbor tables on the basis of a model such that the detection ranges and positions of sensors can be used to figure out which sensors are neighbors. A third way is to determine the nearest neighbor tables by a self-calibrating system of sensors that geographically locate themselves and share data with other sensors to determine amongst themselves which sensor is a neighbor of the other sensors. These three ways could be used in any combination in order to determine the nearest neighbor tables. It should be understood that the nearest neighbor tables may also include additional variables, such as time tolerances between nearest neighbors, which may vary between different nearest neighbors depending on the distances between the sensors. Additionally, the nearest neighbor tables may also include rules on treating backwards and repeating messages. In simple networks, there can be rules that enable the limitations of the sensors to be overcome. For example, there is a limitation that the sensors sometimes go off repeatedly when targets pass, resulting in the sensor sending multiple intersperse messages from two sensors about the same target. A rule may be introduced to ignore repeats of messages for nodes that have already been visited by any one target. Other rules may be implemented depending on the effects of particular targets or sensors.

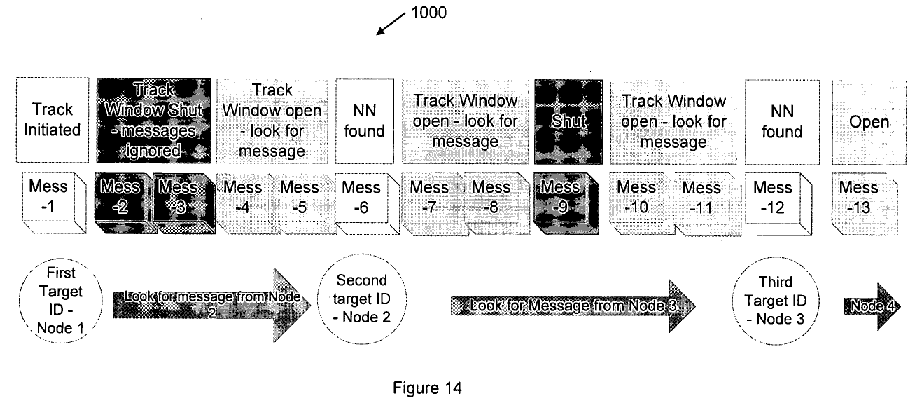

FIG. 14 schematically illustrates a simplified tracking system 100, which may be implemented, for example, by the real time system 230 shown in FIG. 3. As would be understood by those of skill in the art, the system 1000 shows how messages may be identified within moving windows. Once found, the messages from nearest neighbors may be appended to the track for numbered targets, allowing the target to be tracked through the network or sensor array 310. As shown in FIG. 14, a distributed processing system could be used to track targets through the system. In a distributed processing system, the track may be compiled within the sensor array as the target moved through it, with the growing track file to move in concert with the target and relaying the track file back to the user simultaneously. Other systems known to those of skill in the art may be used to track targets through a sensor array 310.

FIG. 14 shows the search process that may be used in analyzing the sensor messages to build up tracks of targets as they move through the sensor array 310. The target is initially detected at Node 1 and a new track file is started. The tracking module then looks at the next messages sent by the sensors in order to find a message from one of Node 1's nearest neighbors. If the tracking module does find one, it appends this node's identification to the track file and repeats the process, now looking for the nearest neighbors of this node. Nodes may be looked for within a window defined by a set time (or number of messages)±the tolerance on this time (or number of messages), for example. As a result, there may be a moving window looking for track updates as messages arrive. With this arrangement and additional heuristics run in parallel, the track may be accurately developed.

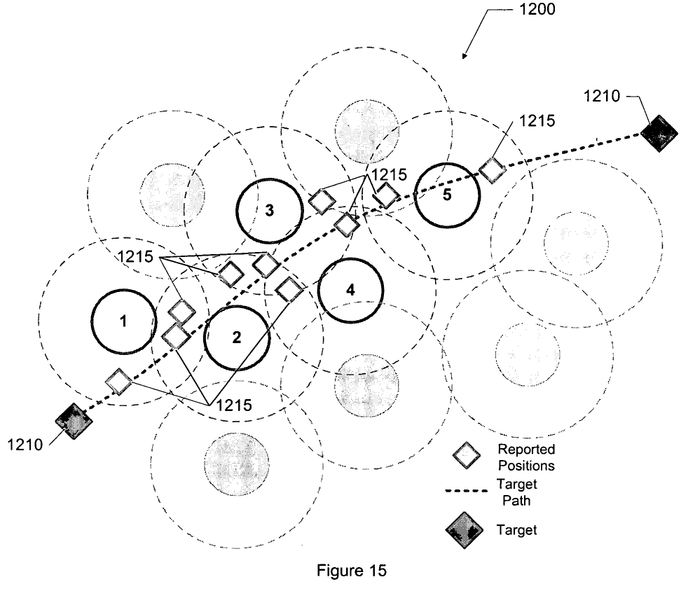

FIG. 15 schematically illustrates a sensor array 1200 and a target 1210 moving through the sensor array 1200. As shown, the target 1210 may be sensed by sensors 1-5. FIG. 15 also shows the locations 1215, representing each time the target 1210 is sensed by the sensors in the sensor array 1200. Referring back to FIG. 14, the tracking mechanism may produce sensor messages of detections when the target crosses into the circular area around a sensor, representative of the coverage. As illustrated, the target 1210 may initially trigger sensor 1, and then sensor 2, and then sensors 3, 4, and 5 as the target moves through the network. Messages generated by the sensors will be sent back to a user running the tracking code. Because there is the possibility of many messages sent from other parts of the sensor array 1200, the tracking mechanism's job is to logically connect these messages back together by looking for sequences of messages from nearest neighbors as illustrated in FIG. 14.

During use of a surveillance system in accordance with an embodiment of the invention, several tracking conditions will likely be present at any given time. For example, while in the process of tracking, the system may experience incomplete tracks (where the system is currently tracking a target in the network), complete tracks (where the system has just finished tracking a target that left the area covered by the sensor array), and a series of ‘aborted’ tracks (represented by either one of: (1) false alarms; (2) genuine targets that don't move; and/or (3) genuine targets that the system fails to track), for example. For incomplete and finished tracks the real time system may be configured to pass these tracks into a process that completes several comparisons of the track to the pattern of life model. Referring to FIG. 3, these comparisons may take place in boxes 233, 234, and 235.

In order to appreciate whether the behavior of a target being tracked is anomalous or not, the system may employ a series of escalating discriminators that build towards the generation of an alert or alarm, which may function to identify or highlight the anomalous target to a user.

In order to trigger anomalies that are relevant to the user, it may be useful to develop in the system a sense of perspective. For example, on a busy urban street, anomalies of low significance will occur regularly, unavoidably, and pervasively. In such an instance, there is no point flagging every anomaly of behavior to the user as the alerts would quickly become ignored or a constant distraction. However, in a constrained or empty environment such as an airport or border, any anomaly might be relevant to the user. Therefore, the system may be configured to allow the user to set a ‘threshold’ or ‘threat level’ on the system that sets internal thresholds to decide at what point internal anomaly detection is escalated to users.

Therefore in order to capture relevant anomalies, thresholds may be used to adjust the sensitivity of the overall surveillance system to balance frequent and distracting false alerts and potentially vital information. These internal thresholds may be linked to an external threshold, such as one set by the user, and/or the system may vary the threshold depending on the different types of anomalies and detection processes. The threshold may also vary depending on the size of the target's deviation from normal as detected by the system.

As a result, one embodiment of the surveillance system may be configured with four levels of anomaly detection, for example. Three may be based on the pattern of life, and one may be based on direct user input. By using multiple levels of anomaly detection, the system may be configured to trigger alerts based on any combination of anomaly detection. As an example, the system could be configured to issue an alert only when two or more of the levels of anomaly detection have been triggered.

The first anomaly detection mechanism, shown in box 233 in FIG. 3, may be a link by link anomaly detection mechanism. The link by link anomaly detection addresses anomalies by determining whether what a target is doing has been seen before frequently or infrequently. The link by link detection mechanism only appraises a target's movement between individual virtual or real nodes and compares that movement to the normalized weight provided by the pattern of life model for that particular transition between nodes. If the system determines that the normalized weight for that target's actual movement is below the threshold set for the system, then the link by link anomaly detection mechanism may be triggered.

If the target travels between two nodes that, according to the data structure, is frequently traveled, the system will return a higher weight (up to a maximum of one). If the target travels between two nodes that, according to the data structure, are rarely traveled in the pattern of life model, the comparison and the system will return a low number (down to a minimum of 0). If the number returned is below a system determined or user defined threshold, a ‘link by link’ alert may be tagged to the target.

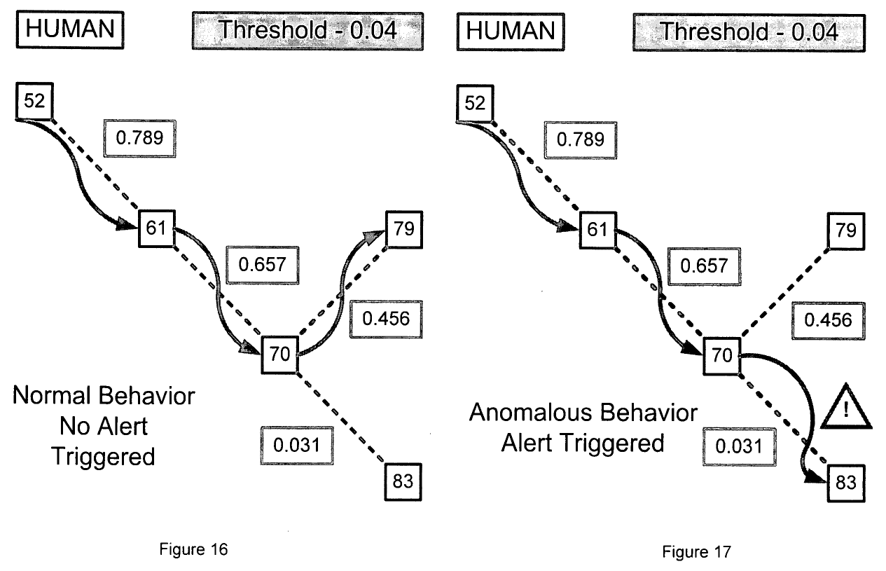

FIGS. 16 and 17 schematically illustrate how a link by link detection mechanism may function as a human target moves through a sensor array represented by nodes 52, 61, 70, 79 and 83. As shown in FIG. 16, the normalized weights for the transitions between nodes are displayed. If the link by link threshold is set to 0.040, then no alert will be triggered because the transitions between nodes 52 and 61, 61 and 70, and finally 70 and 79 are all greater than 0.040. However, for FIG. 17, the link by link detection mechanism may be triggered when a human target decides to move from node 70 to node 83 instead of traveling to node 79. This is because the normalized weight between node 70 and node 83 is 0.031, below the threshold of 0.040. The real time system may be configured to tag the target as anomalous whenever that target moves between two nodes, where the frequency of travel seen previously and hence built into the pattern of life is lower than the system threshold. Depending on the configuration of the real time system, an alert may be raised directly to the user or the system may wait to see if the target triggers any additional detection mechanisms before alerting the user to the target.

Another detection mechanism may be based on the path or tree structure of the pattern of life model derived from the more complex search performed across the data shown and described with reference to FIGS. 8-12. Because the tree structure or path structure originates from the initial target identification, or initial node detection, at each node there are several directions in which a target can move, each associated with a weight. From each node, the various weights may be used to derive a ‘most-likely’ next step or choice for a target to take from the sensor node it has been detected at. As shown in FIG. 3, this detection mechanism may be represented by box 234 as a prediction basis anomaly detection mechanism.

As will be appreciated by those of skill in the art, knowledge of the most likely path may be used to allow discrimination of behaviors that might otherwise be missed by the earlier check. For example, a target may leave a busy high street and move across the road onto a nearby open piece of land. If this behavior is common enough, then the threshold may not be high enough to trigger an alert. However, the fact that the vast majority of people continue traveling down the high trafficked street rather than crossing onto the scrap land means that this behavior is atypical, if not infrequent.

Combining the link by link detection mechanism and the prediction based detection mechanism, the system may detect targets doing things that are not only observed infrequently or not at all, but are also different from the most likely behavior. This may be accomplished by taking the difference between the normalized weight for the most likely path and the normalized weight of the actual path taken by a target. If the difference is greater than some predictive threshold, then the prediction based detection mechanism may tag the target as anomalous.

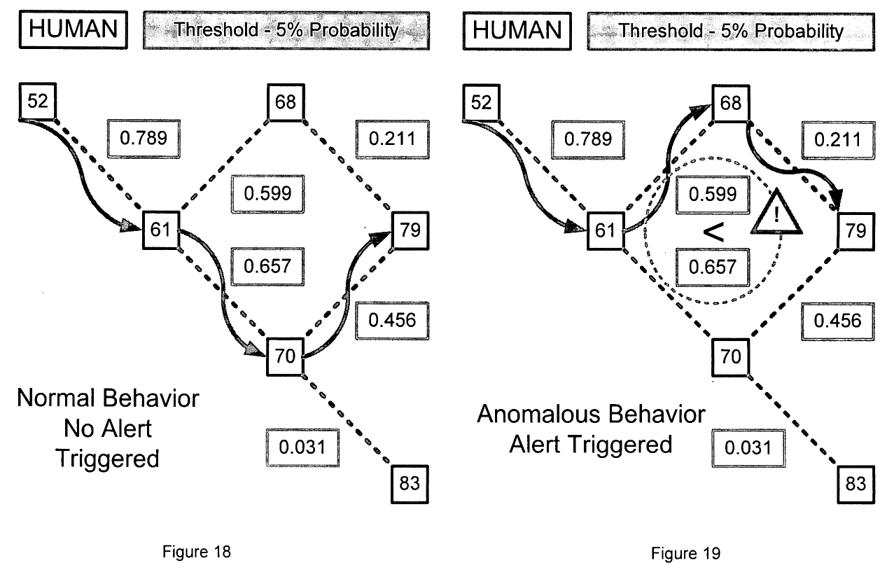

FIGS. 18 and 19 illustrate how a prediction based detection mechanism may function as a target moves through a sensor array represented by nodes 52, 61, 68, 70, 79, and 83. The predictive analysis of the behavior of targets runs as the target is tracked and may be triggered whenever a target takes a route that differs from the most likely path by a predictive threshold. In FIGS. 18 and 19, the predictive threshold may be set at 0.050. This number 0.050 (or 5% as illustrated in the figures) may refer to the minimum difference between the weights of the predicted track and the actual track. As an example, for a predicted link weight of 0.650, an alert would be generated if the actual path followed has a weight of less than 0.600. While traveling from node 52 to node 79, a target is presented with a choice to pass through node 68, with a normalized weight of 0.599 between nodes 61 and 68, or node 70, with a normalized weight of 0.657 between nodes 61 and 70. As such, the most likely path would be to choose to pass through node 70 when traveling to node 79. In FIG. 18, difference between the most likely path and the actual path is 0.000, which will not trigger the prediction based detection mechanism because 0.000 is below the predictive threshold of 0.050. However, in FIG. 17, the difference between the most likely path and the actual path is 0.058, which will result in the target being tagged as anomalous because 0.058 is greater than the predictive threshold of 0.050. Again, depending on the configuration of the real time system, an alert may be raised directly to the user or the system may wait to see of the target triggers any additional detection mechanisms before alerting the user to the target.

As would be apparent to those of skill in the art, the most likely path and the prediction based detection mechanism may applied to a series of nodes as well. For example, the difference between the most likely path from node 61 to node 79 (the path shown in FIG. 18) and the less likely path from node 61 to node 79 (the path shown in FIG. 19) is 0.303, equivalent to 0.657+0.456−0.599−0.211. Because 0.303 is greater than 0.050, the prediction based detection mechanism may tag the target as anomalous. Again, the predictive threshold may be determined by the system by evaluating the data structure of the pattern of life model or may be user defined in order to adjust the sensitivity of the system detections.

Another detection mechanism based on the pattern of life comparison may include an end to end detection mechanism, as shown in box 235 in FIG. 3. The end to end detection mechanism may be configured to consider the target's path as a route between nodes, looking at the total weight of all the nodes traversed. This constitutes evaluating the path the target has taken, together with its likelihood. The sum of the weights of a particular path can be seen as a measure of the overall behavior of the target. Under the previous two detection mechanisms, anomalies may be triggered if the target moved in an anomalous manner by determining if the target behaved unpredictably. However, it is possible to avoid standing out from the crowd. For example, if a target wishing to avoid triggering an alert, a target could simply loiter on a busy street by moving up and down the street, looping back upon himself. The targets actions will be masked by the high traffic of the crowds on the street to be detected by the link by link detection mechanism, and such a path would most likely be detected by the prediction based detection mechanism. However, a target loitering up and down a street by looping back instead of proceeding through and moving on may be an anomalous behavior.

To detect such behavior, an end to end weighting of the total path may be used to determine if there is anything unusual about the overall path taken by a target. The end to end detection mechanism may be configured to detect multiple types of anomalous behavior. Again, a threshold, determined by the system or user defined, may be used to adjust the sensitivity of the system.

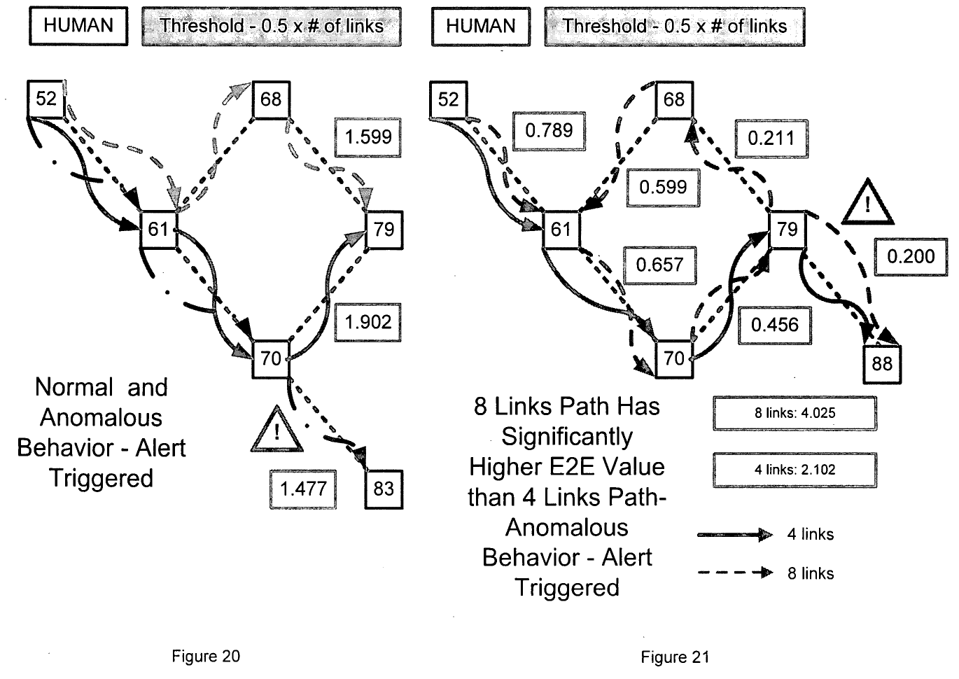

FIGS. 20 and 21 illustrate two separate types of anomalous behavior detected by the end to end detection mechanism. FIG. 20 illustrates how the choice of paths may trigger the end to end detection mechanism. For example, with a threshold set at 0.500 times the number of nodes traversed, a target may be tagged if the total path weight is less than the threshold. A target traveling from nodes 52 to node 61, to node 68, and finally to node 79 would not trigger the end to end detection mechanism because the total weight for the path would be 1.599, greater than the threshold of 1.5 (equal to 0.500 times 3 nodes traversed) for such a path. Similarly, the path from node 52 to node 61 to node 70 and finally to node 79 would also not trigger the end to end detection mechanism because such a path would have a weight of 1.902. However, the path from node 52 to node 61 to node 70 to node 83 would trigger the end to end detection mechanism because the weight for such a path would be 1.477, less than the threshold for 1.5.

An end to end alert may also be triggered if the total path between a beginning node and an ending node is greater than a threshold equal to a standard number (0.500 in the previous example) multiplied by the number of links. This end to end analysis may be suited for determining whether a target has been loitering along a busy street. For example, as shown in FIG. 21, a target may travel from node 52, to node 61 to node 70 to node 79. But instead of traveling directly to the ending node 88, the target may loop around by traveling to node 68 and again to node 61. The target may then return to node 70 and node 79 before traveling to the ending node of 88. The total weight for the looping path would be 4.025, greater than the threshold of 4.000, for 8 traversed links (assuming a threshold of 0.500 per link). This route may not trigger the other alert mechanisms either since the target always stayed to high weighted links and always took the most likely route. However, the total of 4.025 is significantly greater than if the target had traveled directly to node 88 from node 52 (which may represent the most traveled path between nodes 52 and 88), which would be 2.102 when passing through node 70 and 1.799 when passing through node 68. In this comparison of the totals 4.025 and 2.102, the previously discussed thresholds may not be applicable to the differences between the totals. As an alternative, one option may include alerting the user when a route taken by a target between nodes 52 and 88 is not greater than some percentage of the shortest path or the most-traveled path between nodes 52 and 88. For example, in this case, an alert may issue if the percentage threshold is set at 50%, because weight 4.025 is more than 50% greater than weight 2.102.

As discussed earlier, one way to apply a user influence on the detection of threats and anomalous behavior includes the ability of the user to adjust the threshold levels for the various detection mechanisms. This allows customization of the internals of the real time system to turn up or down the sensitivity and hence the number of anomalous targets returned. Additionally, it should be understood that there may be many instances of highly sensitive areas where users might want to know of all behaviors in a given environment regardless of whether behavior has triggered threshold as abnormal. For example, a choke point, laden with sensors, together with camera equipped nodes, could be set up to alert and return imagery of all targets progressing through the gap, even though by its very nature, traffic normally passes through the choke point and would therefore probably not show up as anomalous.

Alternatively, there may also be instances of an area of insignificance where any anomaly, however significant, can be safely ignored. For example, if sensors could see behind a perimeter fence where friendly forces were operating, but were acting abnormally, it may be possible that the system would trigger alerts based on friendly activity. These alerts may potentially clog the network or divert cameras and other assets. If a potential ‘safe’ zone occupied by friendly forces can be defined, the system may ignore the behavior in the ‘safe’ zone and focus on other areas. As such, the thresholds for the system may be adjusted by value, location, time of day, or other such variables, such as season, lighting, or weather, in order to adjust the sensitivity of the system to the user's preferences.

In addition to detection mechanism using the pattern of life model, the surveillance system may use a traditional user defined anomaly detection mechanism, as shown in box 236 in FIG. 3. The user may employ user traditional user defined triggers, such as a virtual trip line surrounding a building or complex where any detections would immediately trigger an alarm. A user defined trigger may alert the user if a target remains stationary for a predetermined time, such as fifteen minutes, for example. Additional sensors such as cameras may be set up to trigger detection mechanism alerts, trigger pattern of life alerts or user defined alarms. Additional user defined triggers may be deployed, such as a trigger set to take a picture of a target crossing a bridge only if that target has been previously tagged by a detection mechanism. Obviously, the system may also be configured to take a picture of any target crossing the bridge.

Therefore, the user may include both pattern of life detection mechanisms and user defined detection mechanisms for allowing the user to define zones on top of the structure of the pattern of life analysis. It is also possible to allow the user to selectively apply an over riding priority to some alerts. For example, the user may be interested in all traffic over the bridge as a priority over other alerts or anomalous behavior taking place in other parts of the sensor array. Such priorities may be generally applied by placing zones of priority over the data structure or layout of the sensor array. For example, a target may be tracked as it is moving toward a bridge, but only triggers an alert to take a picture of the target when the target enters the user defined zone on the bridge. It then triggers an alert and turns on the remote cameras that have sight of the target. The images are returned to the user, and stored locally. The user is then well placed to verify all traffic crossing the bridge.

It should be understood that the system may be configured to distinguish between friendly and enemy forces. It may be preferable to remove friendly activity from the situational awareness display or display the friendly targets with special indicators, such as blue symbols.

It is contemplated that embodiments of the invention may be configured to generate difference types of alarms depending on the type of anomalous detection. As an example, the output from the alerting system 237 may include three single alerts from three pattern of life comparison detection mechanisms discussed above, and a single overriding alert from any user defined detection mechanism. These alerts could be used in any way possible, as required by the system. For example, the alerts may be generally hidden from the user until sufficient anomalous behavior has been identified to justify raising an alarm to the user. For example an alert raised by the link by link detection mechanism 233 may detect movement in parts of the pattern classed as infrequent by comparison to the link by link data in the pattern of life model if the value returned is less than a threshold. However, an alert by the link by link detection mechanism 233 may be of low significance and prone to false alerts.

An alert raised by the prediction based detection mechanism 234 may detect movement from one node to another node defined as less likely than movement from that node to a ‘most likely’ one if the difference is between the most likely path and the actual path is greater than a predictive threshold. An alert by the prediction based detection mechanism 234 may be of medium significance but may be confusing when the alert highlights a relatively highly used path just because the most likely path is very highly used.

An alert raised by the end to end detection mechanism 235 may detect overall abnormal behavior even when individual movements by a target may not trigger an alert. As discussed this may be accomplished by comparison of the end to end weightings of a targets path against a system threshold. Lack of a value indicates an anomaly in that a new or novel behavior had never been seen in analysis of the pattern of life data. The lack of a value indicates that there is no basis for comparison. An alert by the end to end detection mechanism 235 may be of high significance, especially when there is a highly developed pattern of life model.

Once an alert has been generated inside the detection mechanisms, it is contemplated that an alert handling mechanism as shown in box 237 in FIG. 3 may be used to evaluate whether or not to issue an alarm to the user of the system. This determination could vary in complexity. For example, the system could simply alert the user when any alert is identified or when certain combinations of alerts are identified.

Based upon one configuration of an embodiment of the real time system, any time more than one alert is generated by the pattern of life based detection mechanisms, a trigger should issue an alert to the user. If a user defined detection mechanism is triggered, an alert will automatically be issued to the user. Once an alert is triggered for identification to the user, identification of the alert may be made to all users of the system. Alternatively, additional customization may be made to the system such that only certain alerts are issued to some users while other alerts are system wide and are provided to all users. In the event an alert is issued to the users of the system, the anomaly may be shown on all laptops 340 associated with the system for observation by the users. In some instances, an alert may be as simple as displaying an icon on the screen at the location of the anomaly. It is also contemplated that the system may be configured to cue remote cameras to capture visual imagery of an anomalous target when an alert is issued to the user. Such captured imagery may be displayed concurrently with the anomalous target icon. It should be understood that many other combination of displays and automatic responses may be configured and customized by users of the system.

As will be apparent to those of skill in the art, there may be other benefits that come from the use of pattern of life model. Stochastic and random false alarms are natural and expected consequences of any surveillance system. However, while some false alarms will be indistinguishable from accurate single detections of a target, the pattern of life model and the real time system requires track files to be generated. As such, it is unlikely that random false alarms will form tracks. Once the pattern of life model includes sufficient fidelity, the system may be given a threshold sufficient to exclude single false alarms from triggering alarms.

Non-stochastic false alarms may also be unlikely to cause tracks. For example, false alarms caused by a setting sun may induce certain tracks that may be incorporated into the system. However, even such false alarms may likely be avoided by adjusting the threshold of the system once the pattern of life model has sufficient fidelity.

The ability of the system to filter out unimportant or false alarms may be very valuable. This is particularly useful when operating a surveillance system in an urban environment, as a user's screen in such an environment is likely to be often full of detections. As described herein, the system may be configured to give the anomalous detections priority, allowing the user to give precious attention to those detections that deserve attention.

When generating the pattern of life model, there may be several user variables that can be altered to affect the pattern of life model. The following chart illustrates a series of possible variables and the sub-systems they affect. It should be understood that values for these variables may be self generated or self calibrated by the pattern of life model or may be user defined. Not all of these variables need to be used and other variables may be also used.

| Variable | Effect | Metric | Static or Variable once Optimized |
|---|---|---|---|
| Depth of Recursion | Likelihood of connecting | Variable | Static |
| | one node with another; | | |
| | length of track found | | |
| | during reconstruction | | |
| Human time | Determines the amount | Number of | Depends on environment - i.e. Variable |
| | of time the system waits | messages or | |
| | for a new target detection | time limit | |
| Car time | Determines the amount | Number of | Depends on environment - i.e. Variable |
| | of time the system waits | messages or | |
| | for a new target detection | time limit | |
| Tolerance on | Sets the limits either side | Size of | Depends on environment - i.e. Variable |
| Human Time | of the human time value, | time/message | |
| | creating a window | window | |
| Tolerance on Car | Sets the limits either side | Size of | Depends on environment - i.e. Variable |
| Time | of the car time value, | time/message | |
| | creating a window | window | |
| Heuristics Toggle | Turns on or off rules | 0/1/2 | Static |
| | governing the search | | |
| Nearest Neighbors | Determines whether or | Node ID's of | Depends on environment - i.e. Variable |
| table | not one node is a | Nearest | |
| | neighbor of another | Neighbors | |

When using the real time system and tracking targets, there may be several user variables that can be altered to affect the tracking and how the pattern of life model is used. The following chart illustrates a series of variables and the sub-systems they affect. It should be understood that values for these variables maybe self generated or self calibrated by the pattern of life model or may be user defined. Not all of these variables need to be used and other variables may be also used.

| Variable | Effect | Metric | Static or Variable once Optimized |
|---|---|---|---|
| Human wait time | Determines the amount of | Number of | Depends on environment - i.e. Variable |
| | time the system waits for | messages or | |
| | a new target detection | time limit | |
| Car wait time | Determines the amount of | Number of | Depends on environment - i.e. Variable |
| | time the system waits for | messages or | |
| | a new target detection | time limit | |
| Tolerance on | Sets the limits either side | Size of | Depends on environment - i.e. Variable |
| Human Time | of the human time value, | time/message | |
| | creating a window | window | |
| Tolerance on Car | Sets the limits either side | Size of | Depends on environment - i.e. Variable |
| Time | of the car time value, | time/message | |
| | creating a window | window | |
| Nearest Neighbors | Determines whether or | Node ID's of | Depends on environment - i.e. Variable |
| table | not one node is a neighbor | Nearest | |
| | of another | Neighbors | |

It should be understood that the pattern of life generation system may be configured to incorporate behavioral data in real time, even if a fixed pattern of life had been developed previously from the same network or sensor array. Additionally spreading the processing and addition of each track to the pattern of life when it occurs lowers the processing requirements of the system.

There are several advantages to this approach. First, it may be easier to incorporate the data into the real-time system, allowing the architecture to become more useable. Second, it may allow for the gradual drift, change or sheer alteration of the pattern of life to be captured. Although there will always be a lag in the fidelity of the pattern of life as changes happen to the environment, the addition of real-time changes to the pattern of life allows the pattern to be as current as possible. Third, it may allow for the user to correct the system and to exclude repetitive false alarms and to highlight anomalous areas as they are identified.

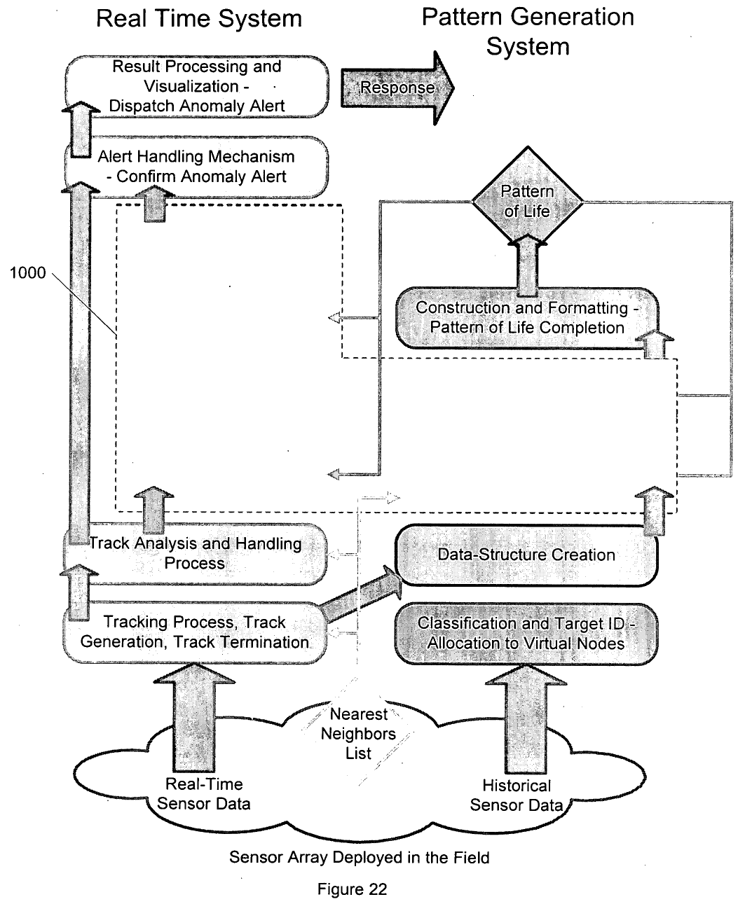

It is also contemplated that a neural network approach to the entire system may be taken. For example, one way of achieving real time generation and updates to the pattern of life model and of more completely searching the data structure for patterns, is to replace the pattern of life generation side with a neural network that performs some real time system functions and some pattern of life model generation functions. Because a neural network's capacity for pattern matching while also amending the weights within itself that represent the pattern, it would be a simple matter to collect the pattern of life in real time. It would also add to the search capacities, and in extracting confidence levels from the system. One example of implementing such a neural network 1000 is shown in FIG. 22.

In one alternative embodiment, rather than use hard thresholds and user defined zones, the system may be configured to define alert states and anomalous alert thresholds using fuzzy logic. As an example, very complicated alert triggers could be established, such as using fuzzy logic to alert a user only about aberrant behavior that is close to him, and only vehicle anomalies between the school and the church across the road.

It is also contemplated that the system may scale the thresholds needed to trigger an alert by the number of previous alerts and the users' responded to. This could be modified by distance to the user, target speed, uncertainty, type of target, etc. All of these variables could be selected from drop down lists and acted upon by a fuzzy logic engine, after consultation with users for details of what they might actually use, for example.

In another alternative, the system may be configured to allow the user, or the system itself to tag aspects of the physical environment. For example, the system may be configured to allow a user to label a wall present in the environment a ‘wall’ on the display. This would allow the system to use that, together with the pattern of life, to apply fuzzy logic and heuristic rules to make the whole sensor array more intelligent and to provide the right information promptly. For example, the system may then be capable of understanding that human and vehicular targets are not going to walk or drive through a wall. It is contemplated that some such information may be gleaned from the historical data collected by the sensor array.

Once tagged the system would then be able to interpret such user rules as ‘it is anomalous to cross this fence line’ or ‘cars should not be parked on pavements’ and could trigger alerts based upon these occurrences. This begins to give the low level sensors, coupled with the pattern of life, and the user definition level the capability of approaching the instinctive response of humans to these kind of situations.

It should be understood that many different types and applications of sensors may be used in connection with embodiments of this invention. Embodiments of the invention may also be applied to all sensors and not only for point detection systems that are arranged in a distributed manner. For example, a radar system could be included within a sensor array by making a few simple assumptions between the output of the range and bearing data from the radar and its entry into the pattern of life system.

Embodiments of the invention may depend on the assumption that a target be able to move between identifiable positions. As such, there may be no need to develop a pattern of life model with fidelity down to a centimeter of position precision if half the sensor assets can use only 50 m as their lowest resolution. Consequently, when using a radar sensor there may be an effective ‘bin’ size between which the transitions can be monitored. Each bin would replace the notion of a virtual node around a sensor so the field of the range and bearing sensor would be divided into multiple bins. Sensors within the field of view of the radar sensor would then share bins based upon their location. Some form of data fusion could be used to correlate bins that are occupied by reference to all suitable sensors. This assumption may be used to avoid the problem of range and bearing radar sensor's ‘over-precision’.

Mobile sensors, such as unmanned aerial vehicles and satellites, likewise may be incorporated so long as there is a data fusion layer to transfer the targets identified from its moving data structure back into the correct bins for the pattern of life model. With this assumption all sensor types should be suitable for use with the pattern of life model.

Likewise the sensors of a sensor array and their communications backbone may be used interchangeably with embodiments of the invention because there is no dependence on the transmission medium. Additionally, multiple systems may be combined to fuse data together. As such, the system may use wifi, radio, and Ethernet together at the same time.

Finally, when using a tracking system in accordance with embodiments of the invention, a variety of algorithms, approaches and methodologies may be used. These can include point detection systems, Kalman filters, auction based systems and any others. Within the scope of virtual nodes, or bins, as described above, these methods may be used irrespective of the tracking system used.

It is also contemplated that the sensors in the sensor arrays may be used to derive their own edge list or nearest neighbor table from their internal process of localization, time calibration and initial network formation. For example, much of this nearest neighbor information may be found in a routing table. This information could then be reported centrally and compiled into the nearest neighbor table for use by the system generally. In the event that a sensor is lost or destroyed, this approach could be used to keep the nearest neighbor table current. As would be understood by those of skill in the art, other strategies may exist for the generation of the nearest neighbor table.

Whereas the present invention is described herein with respect to specific embodiments thereof, it should be understood that various changes and modifications may be made by one skilled in the art without departing from the scope of the invention. It is intended that embodiments of the invention that encompass such changes and modifications fall within the scope of the appended claims.

What is claimed is:

1. A method of detecting behavior, comprising:
sensing a target at a series of nodes using a plurality of sensors as the target moves through the plurality of sensors;
determining whether any two successive nodes in the series of nodes are nearest neighbors to each other;
retrieving a transition weight for a movement between two successive nodes in the series of nodes if the two successive nodes are nearest neighbors; and
alerting a user based, at least in part, on a comparison of the transition weight for the movement between the two successive nodes and a transition threshold.

2. The method of claim 1, wherein the behavior detected comprises anomalous behavior.

3. The method of claim 1, wherein two nodes are defined as nearest neighbors when the target can move between the two nodes without being sensed by another node.

4. The method of claim 1, further comprising:
determining a path weight for a path taken by the target from a first node to a final node, the first node and the final node belonging to the series of nodes;
determining a most-traveled-path weight from the first node to the final node; and
alerting the user based, at least in part, on a comparison of the path weight of the target's path and the most-traveled-path weight between the first node and the final node.

5. The method of claim 1, further comprising:
determining a path weight for a path taken by the target from a first node to a final node, the first node and the final node belonging to the series of nodes;
determining a shortest-path weight from the first node to the final node; and
alerting the user based, at least in part, on a comparison of the path weight of the target's path and the shortest-path weight between the first node and the final node exceeds a path threshold.

6. The method of claim 1, further comprising:
retrieving path data for all paths originating from a first node to sense the target, the first node belonging to the series of nodes;
sensing the target at a second node, the second node defined as one of the series of nodes after the first node;
determining a transition weight from the path data corresponding to a movement between the second node and the next node most likely to sense the target; and
sensing the target at a third node, the third node defined as one of the series of nodes after the second node;
retrieving a transition weight between the second node and the third node; and
alerting the user based, at least in part, on a comparison of the transition weight between the second node and the third node and the transition weight between the second node and the next most likely node.

7. The method of claim 1, further comprising:
determining a total path weight corresponding to the sum of the transition weights between the nodes in the series of nodes; and
alerting the user if the total path weight is less than the number of transitions between nodes in the series of nodes multiplied by an end-to-end threshold.

8. The method of claim 1, further comprising:
calculating the transition weights between the nodes in the plurality of sensors by using a set of historical data and the series of nodes sensing the target.

9. The method of claim 8, wherein calculating the transition weights between the nodes is done as the target travels through the plurality of sensors.

10. The method of claim 1, wherein the plurality of sensors comprise at least one of the following types of sensors: acoustic, electromagnetic spectrum, seismic, vibrational, magnetic, radar, lidar, infrared, ultrasonic, beam-breakers, x-ray, laser, microwave, video, or audio.

11. The method of claim 1, wherein alerting the user comprises sending an image of the target to the user.

12. The method of claim 1, further comprising:
classifying the target into a target class, the target class includes at least one of a human or a vehicle.

13. A system for detecting behavior, comprising:
a plurality of sensors having a plurality of nodes configured to sense a target moving through the plurality of sensors; and
a processing system configured to:
receive a first signal from a first node of the plurality of nodes to sense the target;
receive a second signal from a second node of the plurality of nodes to sense the target;
determine whether the second node is a nearest neighbor to the first node;
retrieve a transition weight for a movement between the first node and a second node if the second node is a nearest neighbor to the first node; and
alert a user if the transition weight for the movement is less than a threshold.

14. The system of claim 13, wherein the behavior detected comprises anomalous behavior.

15. The system of claim 13, wherein two nodes are defined as nearest neighbors when the target can move between the two nodes without being sensed by another node.

16. The system of claim 13, wherein the processing system is further configured to:
retrieve path data for all paths originating from the first node;
determine a next node most likely to sense the target from the path data;
retrieve a transition weight between the second node and the next most likely node;
receive a third signal from a third node of the plurality of nodes;
determine whether the third node is a nearest neighbor to the second node;
retrieve a transition weight between the second node and the third node if the third node is a nearest neighbor to the second node; and
alert a user if the transition weight between the second node and the third node is less than the transition weight between the second node and the next most likely node.

17. The system of claim 16, wherein the processing system is further configured to:
receive a final signal from a final node;
determining a path weight for a path taken by the target from the first node to the final node;
determining a most-traveled-path weight from the first node to the final node; and
alerting the user if the difference between the path weight of the target's path and the most-traveled-path weight between the first node and the final node exceeds a path threshold.

18. The system of claim 17, wherein the processing system is further configured to:
determining a total path weight corresponding to the sum of all transition weights between the first node and the final node; and
alerting the user if the total path weight is less than the number of transitions between the first node and the final node multiplied by an end-to-end threshold.

19. The system of claim 18, wherein the processing system is further configured to alert the user if the target triggers a user-defined rule.

20. The system of claim 19, wherein the user-defined rule includes the target remaining stationary for a predetermined period of time.

21. The system of claim 19, wherein the user-defined rule includes sensing of the target by a predetermined node.

22. The system of claim 13, wherein the processing system is further configured to calculate the transition weights between the nodes in the plurality of sensors by using a set of historical data and the series of nodes sensing the target.

23. The system of claim 22, wherein the processing system is further configured to calculate the transition weights between the nodes as the target travels through the plurality of sensors.

24. The system of claim 13, wherein the plurality of sensors comprise at least one of the following types of sensors: acoustic, electromagnetic spectrum, seismic, vibrational, magnetic, radar, lidar, infrared, ultrasonic, beam-breakers, x-ray, laser, microwave, video, or audio.

25. The system of claim 24, wherein at least one of the plurality of sensors includes a magnetometer and a passive infrared detector.

26. The system of claim 13, wherein the processing system is further configured to alert the user by sending an image of the target to the user.

27. The system of claim 13, wherein the processing system is further configured to classify the target into a target class, the target class includes at least one of a human or a vehicle.
